(19) United States
(12) Patent Application Publication
(10) Pub. No.: US 2026/0350161 A1
(43) Pub. Date: Nov. 5, 2026

(54) MACHINE LEARNING TECHNIQUES FOR DETECTING AND PREVENTING RANSOMWARE ATTACKS

(71) Applicant: Rapid7, Inc., Boston, MA (US)

(72) Inventors: Tom Roter, Tel Aviv (IL); Stuart Millar, Bangor (GB); Denis Kamanovsky, Ram At-Gan (IL)

(73) Assignee: Rapid7, Inc., Boston, MA (US)

(21) Appl. No.: 19/379,398

(22) Filed: Nov. 4, 2025

(30) Foreign Application Priority Data
Apr. 30, 2025 (IL) 320599

(51) Int. Cl. G06F 21/56; G06N 3/0464; G06N 20/00

(52) U.S. Cl. CPC G06F 21/56; G06N 3/0464; G06N 20/00

(57) ABSTRACT

Techniques for mitigating malware attacks in a computer environment by applying one or more trained machine learning (ML) models to features derived from file system application programming interface (API) calls made by computer processes executing in the computer environment, including: capturing file system API calls data about file system API calls made by a computer process executing in an operating system of the computer environment, generating a feature set from the file system API calls data, processing the feature set using a first trained ML model to obtain an ML model output indicating whether the computer process is malicious, and determining whether the computer process is malicious based on the ML model output.

### BACKGROUND

Today, cybercrimes are increasing in frequency, with modern computing environments being susceptible to various types of cyberattacks. One common type of cyberattack is a ransomware attack. Ransomware is a type of malware that restricts access to the infected computer system in some way, and demands that the user pay a ransom to the malware operators to remove the restriction. Some forms of ransomware systematically encrypt files, which become difficult or impossible to decrypt without paying the ransom for the encryption key, while some may simply lock the system and display messages intended to coax the user into paying. Ransomware attacks will typically provide an encryption key or otherwise allow users to regain access to their computer environments when the ransom is paid.

As with other forms of malware, security software might not detect a ransomware attack until the attack is already underway. This is particularly so for ransomware attacks, as these attacks may already have accessed and started to encrypt file system objects within a computer environment before being detected.

If an attack is suspected or detected in its early stages, immediate removal of the malware before it has completed would stop further damage to data but would not salvage any already lost data.

Detecting malware is further complicated by the legitimate computer programs executing within a computer environment, as many legitimate programs have similar behaviors to malware. Therefore, it is important to quickly and accurately identify malicious programs within a computer environment.

### SUMMARY

Some embodiments provide for a method for mitigating malware attacks in a computer environment by applying one or more trained machine learning (ML) models to features derived from file system application programming interface (API) calls made by computer processes executing in the computer environment, is provided, the method comprising: using at least one computer hardware processor to perform: capturing file system API calls data about file system API calls made by a computer process executing in an operating system of the computer environment, the file system API calls comprising multiple sets of file system API calls, the captured file system API calls data comprising multiple file system API calls datasets corresponding to the multiple sets of file system API calls; generating multiple local feature sets from the multiple file system API calls datasets; processing each of the multiple local feature sets using a first trained ML model to obtain respective first trained ML model outputs indicating whether the computer process is malicious; generating a global feature set from the file system API calls data; processing the global feature set using a second trained ML model different from the first trained ML model to obtain a respective second trained ML model output indicating whether the computer process is malicious; and determining whether the computer process is malicious based on the first trained ML model outputs and the second trained ML model output.

In some embodiments, capturing file system API calls data comprises capturing data about file system API calls related to one or more of: reading files, writing files, opening files, creating files, deleting files, allocating memory, mapping memory to a computer function, requesting file attributes, requesting computer process information, changing file object data, and/or requesting file metadata.

In some embodiments, the computer environment is a WINDOWS® computer environment, and wherein capturing file system API calls data comprises capturing data about file system API calls including: NtOpenFile, GetFileAttributesW, GetFileAttributesExW, NtWriteFile, NtReadFile, NtCreateFile, NtDeleteFile, NtMapViewOfSection, NtQueryInformationProcess, NtSetInformationFile, NtQueryDirectoryFileEx, NtQueryDirectoryFile, FindFirstFileW, FindFirstFileNameW, FindFirstFileExW, and/or FindNextFileW.

In some embodiments, each file system API call dataset of the multiple file system API calls datasets and each local feature set of the multiple local feature sets comprise data related to between 5,000 and 15,000 API calls.

In some embodiments, the multiple local feature sets include a first local feature set corresponding to a first data set of API calls, the first local feature set comprising a first set of feature values derived for a first API call, the first set of feature values including: a feature value indicative of a call type of the first API call, a feature value indicative of a time since a previous API call, a feature value indicative of one or more requested file system objects associated with the first API call, a feature value indicative of permissions associated with the first API call, a feature value indicative of attributes of a file system object associated with the first API call, a feature value indicative of actions associated with the first API call, a feature value indicative of a query structure associated with the first API call, a feature value indicative of opening a file system object associated with the first API call, and/or a feature value associated with creating a file system object associated with the first API call.

In some embodiments, the first trained ML model comprises a trained neural network model.

In some embodiments, the trained neural network model comprises at least one one-dimensional convolutional layer.

In some embodiments, the trained neural network model is a convolutional neural network model, comprising an embedding layer, the at least one one-dimensional convolutional layer, a pooling layer, and a fully-connected layer.

In some embodiments, the trained neural network model comprises an embedding layer, the at least one one-dimensional convolutional layer, a long short-term memory (LSTM) layer, an attention mechanism, and a fully-connected layer.

In some embodiments, the global feature set comprises data related to the file system API calls made by the computer process, including one or more of: proportions of API call types of the file system API calls made by the computer process, whether the computer process is signed, a mean time difference between the API calls made by the computer process, a standard deviation of time differences between the API calls made by the computer process, a maximum time difference between API calls made by the computer process, and/or a minimum time difference between API calls made by the computer process.

In some embodiments, the second trained ML model comprises a trained random forest model.

In some embodiments, the second trained ML model comprises a trained random forest model, a support vector classifier, a trained logistic regression model, or a gradient boosted decision tree model.

In some embodiments, the determining comprises determining the computer process is malicious when a combined threat score based on the first trained ML outputs and the second trained ML model output exceeds a threshold score.

In some embodiments, the determining comprises determining the computer process is malicious when: a number of first trained ML outputs indicating the computer process is malicious exceeds a threshold; and the second trained ML output indicates the computer process is malicious.

In some embodiments, the method further comprises: when it is determined the computer process is malicious, performing one or more of: isolating the computer process; terminating the computer process; and/or analyzing actions performed by the computer process.

Some embodiments provide for a system for mitigating malware attacks in a computer environment, is provided, the system comprising: at least one computer hardware processor; and at least one non-transitory computer-readable storage medium storing processor-executable instructions that, when executed by the at least one computer hardware processor, causes the at least one computer hardware processor to perform a method for mitigating malware attacks in the computer environment by applying one or more trained machine learning (ML) models to features derived from file system application programming interface (API) calls made by computer processes executing in the computer environment, the method comprising: capturing file system API calls data about file system API calls made by a computer process executing in an operating system of the computer environment, the file system API calls comprising multiple sets of file system API calls, the captured file system API calls data comprising multiple file system API calls datasets corresponding to the multiple sets of file system API calls; generating multiple local feature sets from the multiple file system API calls datasets; processing each of the multiple local feature sets using a first trained ML model to obtain respective first trained ML model outputs indicating whether the computer process is malicious; generating a global feature set from the file system API calls data; processing the global feature set using a second trained ML model different from the first trained ML model to obtain a respective second trained ML model output indicating whether the computer process is malicious; and determining whether the computer process is malicious based on the first trained ML model outputs and the second trained ML model output.

Some embodiments provide for at one non-transitory computer-readable storage medium storing processor-executable instructions is provided, that, when executed by at least one computer hardware processor, causes the at least one computer hardware processor to perform a method for mitigating malware attacks in the computer environment by applying one or more trained machine learning (ML) models to features derived from file system application programming interface (API) calls made by computer processes executing in the computer environment, the method comprising: capturing file system API calls data about file system API calls made by a computer process executing in an operating system of the computer environment, the file system API calls comprising multiple sets of file system API calls, the captured file system API calls data comprising multiple file system API calls datasets corresponding to the multiple sets of file system API calls; generating multiple local feature sets from the multiple file system API calls datasets; processing each of the multiple local feature sets using a first trained ML model to obtain respective first trained ML model outputs indicating whether the computer process is malicious; generating a global feature set from the file system API calls data; processing the global feature set using a second trained ML model different from the first trained ML model to obtain a respective second trained ML model output indicating whether the computer process is malicious; and determining whether the computer process is malicious based on the first trained ML model outputs and the second trained ML model output.

Some embodiments provide for a method for mitigating malware attacks in a computer environment by applying one or more trained machine learning (ML) models to features derived from file system application programming interface (API) calls made by computer processes executing in the computer environment, is provided, the method comprising: using at least one computer hardware processor to perform: capturing file system API calls data about file system API calls made by a computer process executing in an operating system of the computer environment, the file system API calls data comprising multiple sets of file system API calls, the captured file system API calls data comprising multiple file system API calls datasets corresponding to the multiple sets of file system API calls; generating multiple feature sets from the multiple API calls datasets, each of the multiple feature sets including feature values indicative of a number of times various file system API calls were made by the computer process in a time period during which the corresponding set of file system API calls were made; processing each of the multiple feature sets using a first trained neural network model to obtain respective first trained neural network model outputs indicating whether the computer process is malicious, the first trained neural network model comprising an embedding layer and at least one one-dimensional convolutional layer; and determining whether the computer process is malicious based on the first trained neural network model outputs.

In some embodiments, capturing file system API calls data comprises capturing data about file system API calls related to one or more of: reading files, writing files, opening files, creating files, deleting files, allocating memory, mapping memory to a computer function, requesting file attributes, requesting computer process information, changing file object data, and/or requesting file metadata.

In some embodiments, the computer environment is a WINDOWS® computer environment, and wherein capturing file system API calls data comprises capturing data about file system API calls including: NtOpenFile, GetFileAttributesW, GetFileAttributesExW, NtWriteFile, NtReadFile, NtCreateFile, NtDeleteFile, NtMapViewOfSection, NtQueryInformationProcess, NtSetInformationFile, NtQueryDirectoryFileEx, NtQueryDirectoryFile, FindFirstFileW, FindFirstFileNameW, FindFirstFileExW, and/or FindNextFileW.

In some embodiments, each file system API call dataset of the multiple file system API calls datasets and each feature set of the multiple feature sets comprise data related to between 5,000 and 15,000 API calls.

In some embodiments, the feature values of the feature sets further comprise one or more of: a feature value indicative of a call type of an API call, a feature value indicative of a time since a previous API call, a feature value indicative of one or more requested file system objects associated with the API call, a feature value indicative of permissions associated with the API call, a feature value indicative of attributes of a file system object associated with the API call, a feature value indicative of actions associated with the API call, a feature value indicative of a query structure associated with the API call, a feature value indicative of opening a file system object associated with the API call, and/or a feature value associated with creating a file system object associated with the API call.

In some embodiments, the trained neural network model further comprises a long short-term memory (LSTM) layer, an attention mechanism, and a fully-connected layer.

In some embodiments, the method further comprises; generating a global feature set from the file system API calls data; processing the global feature set using a second trained ML model different from the first trained neural network model to obtain a second trained ML model output indicating whether the computer process is malicious; and wherein the determining is performed further based on the second trained ML model output.

In some embodiments, the global feature set comprises data related to the file system API calls made by the computer process, including one or more of: proportions of API call types of the file system API calls made by the computer process, whether the computer process is signed, a mean time difference between the API calls made by the computer process, a standard deviation of time differences between the API calls made by the computer process, a maximum time difference between API calls made by the computer process and/or a minimum time difference between API calls made by the computer process.

In some embodiments, the second trained ML model comprises a trained random forest model.

In some embodiments, the second trained ML model comprises a trained random forest model, a support vector classifier, a trained logistic regression model, or a trained gradient boosted decision tree model.

In some embodiments, the determining comprises determining the computer process is malicious when a combined threat score based on the first trained neural network model outputs and the second trained ML model output exceeds a threshold score.

In some embodiments, the determining comprises determining the computer process is malicious when: a number of first trained neural network model outputs indicating the computer process is malicious exceeds a threshold; and the second trained ML output indicates the computer process is malicious.

In some embodiments, the method further comprises: when it is determined the computer process is malicious, performing one or more of: isolating the computer process; terminating the computer process; and/or analyzing actions performed by the computer process.

Some embodiments provide for a system for mitigating malware attacks in a computer environment is provided, the system comprising: at least one computer hardware processor; and at least one non-transitory computer-readable storage medium storing processor-executable instructions that, when executed by the at least one computer hardware processor, causes the at least one computer hardware processor to perform a method for mitigating malware attacks in a computer environment by applying one or more trained machine learning (ML) models to features derived from file system application programming interface (API) calls made by computer processes executing in the computer environment, the method comprising: capturing file system API calls data about file system API calls made by a computer process executing in an operating system of the computer environment, the file system API calls data comprising multiple sets of file system API calls, the captured file system API calls data comprising multiple file system API calls datasets corresponding to the multiple sets of file system API calls; generating multiple feature sets from the multiple API calls datasets, each of the multiple feature sets including feature values indicative of a number of times various file system API calls were made by the computer process in a time period during which the corresponding set of file system API calls were made; processing each of the multiple feature sets using a first trained neural network model to obtain respective first trained neural network model outputs indicating whether the computer process is malicious, the first trained neural network model comprising an embedding layer and at least one one-dimensional convolutional layer; and determining whether the computer process is malicious based on the first trained neural network model outputs.

Some embodiments provide for at least one non-transitory computer-readable storage medium storing processor-executable instructions is provided, that, when executed by at least one computer hardware processor, causes the at least one computer hardware processor to perform a method for mitigating malware attacks in a computer environment by applying one or more trained machine learning (ML) models to features derived from file system application programming interface (API) calls made by computer processes executing in the computer environment, the method comprising: capturing file system API calls data about file system API calls made by a computer process executing in an operating system of the computer environment, the file system API calls data comprising multiple sets of file system API calls, the captured file system API calls data comprising multiple file system API calls datasets corresponding to the multiple sets of file system API calls; generating multiple feature sets from the multiple API calls datasets, each of the multiple feature sets including feature values indicative of a number of times various file system API calls were made by the computer process in a time period during which the corresponding set of file system API calls were made; processing each of the multiple feature sets using a first trained neural network model to obtain respective first trained neural network model outputs indicating whether the computer process is malicious, the first trained neural network model comprising an embedding layer and at least one one-dimensional convolutional layer; and determining whether the computer process is malicious based on the first trained neural network model outputs.

Some embodiments provide for method for mitigating malware attacks in a computer environment by applying one or more trained machine learning (ML) models to features derived from file system application programming interface (API) calls made by computer processes executing in the computer environment is provided, the method comprising: using at least one computer hardware processor to perform: capturing file system API calls data about file system API calls made by a computer process executing in an operating system of the computer environment; generating a feature set from the file system API calls data, the feature set including feature values indicative of a number of times various file system API calls were made by the computer process in a time period during which the file system API calls were made; processing the feature set using a first trained neural network model to obtain a first trained neural network model output indicating whether the computer process is malicious, the first trained neural network model comprising an embedding layer and at least one one-dimensional convolutional layer; and determining whether the computer process is malicious based on the first trained neural network model output.

In some embodiments, capturing file system API calls data comprises capturing data about file system API calls related to one or more of: reading files, writing files, opening files, creating files, deleting files, allocating memory, mapping memory to a computer function, requesting file attributes, requesting computer process information, changing file object data, and/or requesting file metadata.

In some embodiments, the computer environment is a WINDOWS® computer environment, and wherein capturing file system API calls data comprises capturing data about file system API calls including: NtOpenFile, GetFileAttributesW, GetFileAttributesExW, NtWriteFile, NtReadFile, NtCreateFile, NtDeleteFile, NtMap ViewOfSection, NtQueryInformationProcess, NtSetInformationFile, NtQueryDirectoryFileEx, NtQueryDirectory File, FindFirstFileW, FindFirstFileNameW, FindFirstFileExW, and/or FindNextFileW.

In some embodiments, the method further comprises: generating a global feature set from the file system API calls data; processing the global feature set using a second trained ML model different from the first trained neural network model to obtain a second trained ML model output indicating whether the computer process is malicious; and wherein the determining is performed further based on the second trained ML model output.

In some embodiments, the global feature set comprises data related to the file system API calls made by the computer process, including one or more of: proportions of API call types of the file system API calls made by the computer process, whether the computer process is signed, a mean time difference between the API calls made by the computer process, a standard deviation of time differences between the API calls made by the computer process, a maximum time difference between API calls made by the computer process and/or a minimum time difference between API calls made by the computer process.

In some embodiments, the second trained ML model comprises a trained random forest model.

In some embodiments, the determining comprises determining the computer process is malicious when a combined threat score based on the first trained neural network model output and the second trained ML model output exceeds a threshold score.

In some embodiments, the method further comprises: when it is determined the computer process is malicious, performing one or more of: isolating the computer process; terminating the computer process; and/or analyzing actions performed by the computer process.

Some embodiments provide for a system for mitigating malware attacks in a computer environment is provided, the system comprising: at least one computer hardware processor; and at least one non-transitory computer-readable storage medium storing processor-executable instructions that, when executed by the at least one computer hardware processor, causes the at least one computer hardware processor to perform a method for mitigating malware attacks in a computer environment by applying one or more trained machine learning (ML) models to features derived from file system application programming interface (API) calls made by computer processes executing in the computer environment, the method comprising: capturing file system API calls data about file system API calls made by a computer process executing in an operating system of the computer environment; generating a feature set from the file system API calls data, the feature set including feature values indicative of a number of times various file system API calls were made by the computer process in a time period during which the file system API calls were made; processing the feature set using a first trained neural network model to obtain a first trained neural network model output indicating whether the computer process is malicious, the first trained neural network model comprising an embedding layer and at least one one-dimensional convolutional layer; and determining whether the computer process is malicious based on the first trained neural network model output.

In some embodiments, capturing file system API calls data comprises capturing data about file system API calls related to one or more of: reading files, writing files, opening files, creating files, deleting files, allocating memory, mapping memory to a computer function, requesting file attributes, requesting computer process information, changing file object data, and/or requesting file metadata.

In some embodiments, the computer environment is a WINDOWS® computer environment, and wherein capturing file system API calls data comprises capturing data about file system API calls including: NtOpenFile, GetFileAttributesW, GetFileAttributesExW, NtWriteFile, NtReadFile, NtCreateFile, NtDeleteFile, NtMap ViewOfSection, NtQueryInformationProcess, NtSetInformationFile, NtQuery Directory FileEx, NtQueryDirectoryFile, FindFirstFileW, FindFirstFileNameW, FindFirstFileExW, and/or FindNextFileW.

In some embodiments, the method further comprises: generating a global feature set from the file system API calls data; and processing the global feature set using a second trained ML model different from the first trained neural network model to obtain a second trained ML model output indicating whether the computer process is malicious, wherein the determining is performed further based on the second trained ML model output.

In some embodiments, the global feature set comprises data related to the file system API calls made by the computer process, including one or more of: proportions of API call types of the file system API calls made by the computer process, whether the computer process is signed, a mean time difference between the API calls made by the computer process, a standard deviation of time differences between the API calls made by the computer process, a maximum time difference between API calls made by the computer process and/or a minimum time difference between API calls made by the computer process.

In some embodiments, the second trained ML model comprises a trained random forest model.

In some embodiments, the determining comprises determining the computer process is malicious when a combined threat score based on the first trained neural network model output and the second trained ML model output exceeds a threshold score.

In some embodiments, the method comprises, when it is determined the computer process is malicious, performing one or more of: isolating the computer process; terminating the computer process; and/or analyzing actions performed by the computer process.

Some embodiments provide for at least one non-transitory computer-readable storage medium storing processor-executable instructions is provided, that, when executed by at least one computer hardware processor, causes the at least one computer hardware processor to perform a method for mitigating malware attacks in a computer environment by applying one or more trained machine learning (ML) models to features derived from file system application programming interface (API) calls made by computer processes executing in the computer environment, the method comprising: capturing file system API calls data about file system API calls made by a computer process executing in an operating system of the computer environment; generating a feature set from the file system API calls data, the feature set including feature values indicative of a number of times various file system API calls were made by the computer process in a time period during which the file system API calls were made; processing the feature set using a first trained neural network model to obtain a first trained neural network model output indicating whether the computer process is malicious, the first trained neural network model comprising an embedding layer and at least one one-dimensional convolutional layer; and determining whether the computer process is malicious based on the first trained neural network model output.

In some embodiments, the method further comprises generating a global feature set from the file system API calls data, and processing the global feature set using a second trained ML model different from the first trained neural network model to obtain a second trained ML model output indicating whether the computer process is malicious, wherein the determining is performed further based on the second trained ML model output.

In some embodiments, the determining comprises determining the computer process is malicious when a combined threat score based on the first trained neural network model output and the second trained ML model output exceeds a threshold score.

In some embodiments, the method further comprises: when it is determined the computer process is malicious, performing one or more of: isolating the computer process; terminating the computer process; and/or analyzing actions performed by the computer process.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A shows an example environment in which an information security system may operate, in accordance with some embodiments of the technology described herein.

FIG. 1B shows components of an example information security system within a computer environment, in accordance with some embodiments of the technology described herein.

FIG. 2 is an example data flow which may be performed by an information security system deployed to a computer environment to identify malware, in accordance with some embodiments of the technology described herein.

FIG. 3A is an example convolutional neural network which may be used by an information security system in identifying malware, in accordance with some embodiments of the technology described herein.

FIG. 3B is an example random forest model which may be used by an information security system in identifying malware, in accordance with some embodiments of the technology described herein.

FIG. 4 is an alternative example data flow which may be performed by an information security system deployed to a computer environment to identify malware, in accordance with some embodiments of the technology described herein.

FIG. 5 is an example convolutional neural network with a long short-term memory layer, which may be used by an information security system in identifying malware, in accordance with some embodiments of the technology described herein.

FIG. 6A is an example process for identifying a malicious computer process, in accordance with some embodiments of the technology described herein.

FIG. 6B is an alternate example process for identifying a malicious computer process, in accordance with some embodiments of the technology described herein.

FIG. 6C is an alternate example process for identifying a malicious computer process, in accordance with some embodiments of the technology described herein.

FIG. 7 shows a block diagram of an exemplary computing device, in accordance with some embodiments of the technology described herein.

### DETAILED DESCRIPTION

Ransomware attacks often begin by identifying a set of files within a computer environment to encrypt. The ransomware may access a location within the file storage of a computer environment, for example a folder or partition, and request metadata related to the file system objects stored in that location. Based on the metadata associated with a file system object, the ransomware determines whether to add the file system object to a list for encryption, skip the object, or perform some other action with the object.

-Ransomware may select file system objects in a computer environment for encryption. File system objects may include various types of objects within a computer environment, for example, folders, system files (e.g., files related to the functioning of a computer environment or a device within a computer environment, such as executable files), and/or content files (e.g., document files, PDF files, picture files, movie files, or text files, among similar files), among other data types.

After determining which files to encrypt, the ransomware will proceed to access the identified file system objects and encrypt the objects, such that their content is no longer accessible to a user of the computer environment. The ransomware may use operating system-based API functions to access the file and generates Read and Write instructions using API calls for requesting overwriting by writing the encrypted version of the file. The ransomware then reads the content of the file system objects in order to encrypt them. The ransomware might read one block from an object, and then immediately overwrite it with an encrypted version thereof or read the whole content of the object, encrypt it while still in the memory and then overwrite the content.

After encrypting a file system object, the ransomware may proceed to encrypt the remaining file system objects within a particular location within the file storage of the computer environment. After encrypting the objects within a particular location within the file storage, the ransomware may proceed to identify other locations within the file storage from which to identify contents to encrypt. Some ransomwares may make a list of objects to encrypt from the entire storage of a computer environment and encrypt all objects together as opposed to moving from location to location.

Conventional techniques for detecting and mitigating ransomware attacks search for signatures of ongoing ransomware attacks within a computer environment. For example, conventional techniques for detecting and mitigating ransomware attacks rely on known attack signatures, such as signatures associated with file system objects being accessed, file system objects being altered, file system objects being encrypted, and/or file system objects being deleted. However, because these techniques rely on known signatures, these attacks are less effective or completely ineffective against new or evolving attacks, for example fileless ransomware which uses legitimate programs on a computer to propagate an attack or polymorphic attacks which continuously change their characteristics.

Other conventional techniques for detecting and mitigation ransomware attacks rely on heuristic-based detection, using behavioral rules to detect suspicious activity within a computer environment, such as unusual file modifications or rapid encryption of files. However, these techniques are prone to false positives as many legitimate processes within a computing environment exhibit similar behaviors to malware, and the rules cannot be well adapted to subtle differences in behavior between malware on the one hand and benign processes on the other.

The inventors have recognized that conventional ransomware detection and mitigation techniques may be improved by analyzing the behavior of computer processes over different time frames using machine learning techniques. The inventors have appreciated that by analyzing both the short-term and long-term behavior of computer processes, malicious processes can be more accurately identified and false positives (e.g., when a legitimate process is identified as malicious) can be reduced.

Accordingly, the inventors have developed new machine learning (ML) techniques for identifying ransomware attacks within a computer environment. The techniques may involve capturing data about API calls made to a file system of a computer environment by a process executing in the computer environment. The file system API calls data may be analyzed and processed to generate one or more feature sets containing data related to the file system API calls. In some embodiments, local feature sets may be generated which contain data related to the most recent file system API calls made by a computer process. In some embodiments, global feature sets may be generated which contain data related to all file system API calls made by a computer process. The feature sets may be passed to one or more trained machine learning (ML) models for analysis. The one or more trained ML models may be trained to identify whether a computer process is a malicious process.

In some embodiments, multiple trained ML models may be used. For example, a first trained ML model may analyze local feature sets (e.g., feature sets including feature values indicative of the behavior of a computer process over a most recent time period), and a second trained ML model may analyze global feature sets (e.g., feature sets including feature values indicative of the behavior of a computer process over multiple time periods or all available time). In other embodiments, a single trained ML model may be used. In some embodiments, a single trained ML model may analyze local and global feature sets. In some embodiments, a single trained ML model may analyze a single feature set. In some embodiments, the single feature set may include features indicative of short-term and/or long-term behavior of a computer process. The one or more trained ML models may be trained using data captured from real-world malicious computer programs (e.g., ransomware, malware) and common legitimate computer programs that execute within a computer environment. The inventors have appreciated that by utilizing multiple ML models, trained on real-world data, to analyze the behavior of computer processes over short-term and long-term timeframes, identification of malicious computer processes may be improved. Training and analysis over multiple time periods and using real world data allows for the recognition of patterns that distinguish behavior of such malware (from legitimate processes). This improves the accuracy and reliability of ransomware detection compared to conventional techniques which rely on known patterns or depend on heuristic rules.

The outputs of the one or more trained ML models may be analyzed to determine whether the computer process is a malicious process. Such techniques allow for malicious computer processes to be quickly and accurately identified based on their behavior over time. This will allow for faster remediation of malicious processes and reductions in false positives. The techniques developed by the inventors have achieved high precision, accuracy, recall and F1 values in testing, demonstrating the improved performance of the techniques described herein. For example, for a first technique that analyzes local feature sets using a first trained ML model and global feature sets using a second trained ML model, the first ML model achieved precision of 0.979, recall of 0.997, an F1 score of 0.988 and an accuracy of 0.988, when analyzing local feature sets and the second ML model achieved an accuracy of 1.00, a precision of 1.00 for legitimate processes, a recall of 1.00 for legitimate processes, a F1 score of 1.00 for legitimate processes, a precision of 1.00 for malicious processes, a recall of 1.00 for malicious processes, and a F1 score of 1.00 for malicious processes when analyzing global feature sets generated from captured data for 100,000 API calls. Furthermore, in a second technique that analyzes feature sets using a trained CNN-LSTM model, the model achieved precision of 0.968, recall of 1.00, an F1 score of 0.984 and an accuracy of 0.983, when analyzing feature sets representative of features of 10,000 API calls made by real-world computer processes executing. Therefore, these results indicate that the techniques developed by the inventors and described herein can accurately distinguish between legitimate and malicious computer processes based on data related to the short-term and long-term behavior of the computer processes.

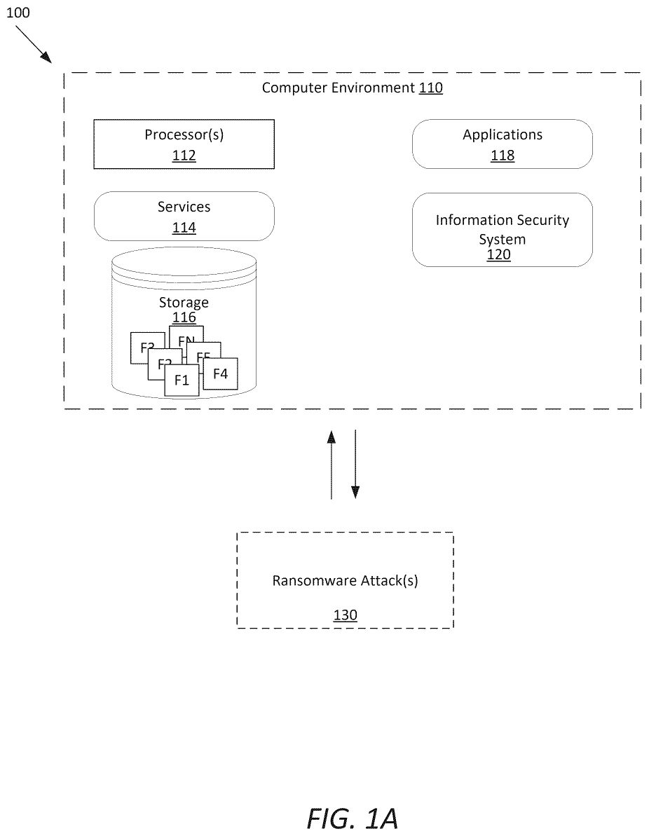

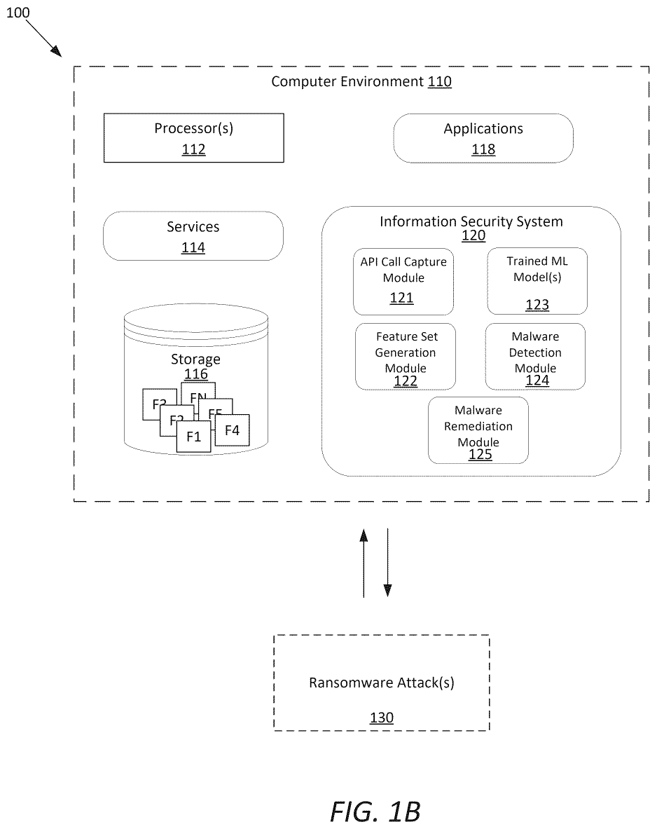

In some embodiments, the techniques described herein may be implemented via an information security system deployed to a computer environment, for example information security system 120 in computer environment 110 of FIGS. 1A-B. In some embodiments, computer environments may include individual devices such as a desktop, laptop, smartphone, server, tablet, IOT device, industry controller device or among other devices. In some embodiments, computer environments may include virtual objects, for example, a virtual container, containers, virtual storage, or among other virtual devices. In some embodiments, computer environments may include one or more interconnected devices, for example, devices connected over a network such as a cloud computing network, a local area network (LAN) or a wide area network (WAN), among other networks. In some embodiments, an information security system is external to the computer environment to which it is deployed. In some embodiments, an information security system is contained within the computer environment to which it is deployed. In some embodiments, an information security system may include one or more modules external to and one or more modules contained within the computer environment to which it is deployed.

In some embodiments, computer environments to which information security systems implementing the techniques described herein may be deployed, for example information security system 120 in computer environment 110 of FIGS. 1A-B, may include file storage for maintaining and controlling access to file system objects within the computer environment. In some embodiments, file storage may be physical data storage directly connected to the computer environment. In some embodiments, the file storage may be storage external to the computer environment and accessible through a network connection. The file storage may store file system objects including documents, office files, image files, video files, audio files, text files, application files, folders, and system files, among other object types. Processes executed within the computer environment may interact with file system objects within the file storage, for example, accessing, deleting, and/or modifying objects.

Computer environments include file systems for managing access to file system objects within the computer environment. File system objects may be stored within the computer environment (e.g., in one or more data bases) or otherwise accessible by the computer environment. Computer processes may make application programming interface (API) calls to the file system of a computer environment. Such API calls may be made to request information (e.g., metadata) related to file system objects, access file system objects, read file system objects, write to file system objects, create file system objects, delete file system objects, move file system objects, or otherwise access or alter file system objects.

The inventors have appreciated that the file system API calls made by a computer process may be analyzed to determine whether the computer process is malicious or not. In some embodiments, as computer processes executing within a computer environment make file system API calls, data about API calls may be captured for analysis by an information security system. In some embodiments, an information security system may capture API calls data from all computer processes executing in a computer environment. In some embodiments, an information security system may analyze API calls data for a particular computer process after a predetermined amount of data has been collected and/or a predetermined amount of time has passed. In some embodiments, API calls data sets may be generated including data related to a predetermined number of captured API calls and/or data related to API calls captured during a predetermined time period. In some embodiments, API calls data sets may be generated when data related to 1,000 API calls, 2,000 API calls, 2,500 API calls, 5,000 API calls, 7,500 API calls, 10,000 API calls, 15,000 API calls, 20,000 API calls, 25,000 API calls, 50,000 API calls, between 1,000-5,000 API calls, between 1,000-10,000 API calls, between 5,000-10,000 API calls, between 10,000-20,000 API calls and/or between 1,000-50,000 API calls, has been captured. In some embodiments, API calls data sets may be generated based on predetermined time periods. For example, a local feature set may be generated using data from API calls captured in the last 10 second, 30 seconds, 1 minute, 2 minutes, 5 minutes, 10 minutes, 15 minutes, 20 minutes, 30 minutes, 1 hour, between 1-60 seconds, between 10 seconds- 5 minutes, between 10 seconds-10 minutes, between 1-10 minutes, between 10 seconds- 30 minutes, and/or between 10 seconds-1 hour. After an API call data set has been generated, it may be analyzed by an information security system to determine whether the associated computer process is malicious. In some embodiments, a size (e.g., number of calls and/or length of time period) of the API call data sets generated is selected to optimize computer efficiency and avoid analyses of likely legitimate computer processes. For example the size may be selected based on the fact that malicious computer programs often make many API calls (e.g., 1000s) in a short period of time (scale of seconds to minutes), whereas legitimate computer processes often make much fewer API calls in the same period of time.

In some embodiments, data about specific file system API calls may be captured for analysis. In some embodiments, data about file system API calls may be captured through function hooking within the computer environment. Data about these specific API calls may be captured because they are more likely to be associated with a ransomware or malware attack than other API calls made to the file system of a computer environment. For example, API calls associated with accessing file system objects, accessing metadata of file system objects, changing file system objects and/or changing metadata of file system objects are likely to be associated with a malicious computer process as ransomware may use such calls in determining what file system objects to encrypt and when encrypting file system objects. Further, API calls associated with mapping memory to computer functions, may be associated with malicious computer processes as such processes will often allocate memory during execution. In some embodiments, the information security system may capture data about API calls related to reading files, writing files, opening files, creating files, deleting files, allocating memory, mapping memory to a computer function, requesting file attributes, requesting computer process information, enumerating files in a location, changing file object data, and/or requesting file metadata. In some embodiments, all file system API calls are captured for analysis.

In some embodiments, the techniques described herein may be deployed in a WINDOWS® computer environment. When deployed in a WINDOWS® computer environment, data about specific file system API calls captured for analysis may include one or more of: NtOpenFile, GetFileAttributesW, GetFileAttributesExW, NtWriteFile, NtReadFile, NtCreateFile, NtDeleteFile, NtMapViewOfSection, NtQueryInformationProcess, NtSetInformationFile, NtQueryDirectoryFileEx, NtQueryDirectoryFile, FindFirstFileW, FindFirstFileNameW, FindFirstFileExW, and/or FindNextFileW. While some embodiments are described with reference to WINDOWS® computer environments, it is to be appreciated that the techniques described herein may be implemented in other computer environments such as LINUX® or MacOS®, such as by using similar API calls and features to those described herein.

Each file system API call made within a computer environment may include data related to features of the API calls, which are captured for analysis. API calls data may include data related to one or more features of the API call, including: a type of call, a time of the call, a signature of the call, file system objects associated with the API call, attributes of file system objects associated with the API call, permissions associated with the API call, one or more actions (e.g., access, read, write, move, delete, etc.) associated with the API call, a query structure associated with the API call, a feature indicative of opening characteristics of a file system object associated with the API call, and/or a feature associated with creating a file system object associated with the API call. In a WINDOWS® computer environment, data related to specific features of an API call may be captured for analysis, including one or more of a DesiredAccess feature associated with the API call, a ShareAccess feature associated with the API call, a CreateDisposition feature associated with the API call, a FileInformationClass feature associated with the API call, an OpenOptions feature associated with the API call, a FileAttributes feature associated with the API call, and/or a CreateOptions feature associated with the API call. In some embodiments, all data associated with an API call may be captured for analysis. In some embodiments, different types API calls may have different features, and data captured for each API call may depend on the features available for the associated API call type.

In some embodiments, after data associated with API calls is captured (e.g., by an information security system), the data may be organized into feature sets for analysis. In some embodiments, a feature set may include data related to all captured API calls. In some embodiments, a feature set may include data related to all features of captured API calls. In some embodiments multiple feature sets may be generated using captured API calls data. In some embodiments, multiple feature sets may be generated over time, as API calls data is captured. In some embodiments, a local feature set may be generated including data related to a most recent set of API calls. In some embodiments, a global feature set may be generated including data related to all captured API calls or a greater portion of captured API calls than the local feature set.

As described above, a local feature set may be generated including data related to a set of API calls. In some embodiments, local feature sets may include data related to the current, short-term, behavior of computer process (e.g., its behavior over a most recent period). In some embodiments, multiple local feature sets may be generated as data related to API calls is captured. In some embodiments, a local feature set may be generated using data of an API calls data set, generated from captured API calls data.

In some embodiments, local feature sets may include feature values related to specific features of API calls. Feature values may be determined from captured data about each API call included in the local feature set. The feature values may be determined based on specific features of the API calls. In some embodiments, a local feature set may include feature values determined from one or more features of API calls, including: a type of call, a time of the call, a time since a previous API call, a signature of the associated API call, file system objects associated with the API call, attributes of file system objects associated with the API call, permissions associated with the API call, one or more actions (e.g., access, read, write, move, delete, etc.) associated with the API call, a query structure associated with the API call, a feature indicative of opening characteristics of a file system object associated with the API call, and/or a feature associated with creating a file system object associated with the API call. In a WINDOWS® computer environment, feature values included in a local feature set include data related to specific features of an API call, including one or more of a type of call, a time of the call, a time since a previous call, a DesiredAccess feature associated with the API call, a ShareAccess feature associated with the API call, a CreateDisposition feature associated with the API call, a FileInformationClass feature associated with the API call, an OpenOptions feature associated with the API call, a FileAttributes feature associated with the API call, and/or a CreateOptions feature associated with the API call.

In some embodiments, a local feature set includes at least a feature value indicative of a type of API call and a feature value indicative of a time of an API call, for each API call in the set of captured API calls data. In some embodiments, different types of API calls may include different associated data, and a local feature set may include feature values associated with the available data for each type of API call. In some embodiments, if a feature is not available for a particular type of API call, a feature value associated with that feature may be null or 0.

In some embodiments, the API call features included in the local feature set are selected because they are likely to be indicative of a malicious computer process (e.g., malware, ransomware, etc.). In some embodiments, local feature sets include a feature indicative of API call types, as malicious processes are more likely to be executing specific API call types when infecting a computer environment (e.g., accessing file system objects, reading file system objects, writing to file system objects, enumerating file system objects, allocating memory, etc.), therefore the API call type is an important indicator of whether a process is malicious. In some embodiments, local feature sets include features indicative of a time of an API call and/or a time since a previous API call, as malicious processes typically will execute calls in rapid succession to maximize their spread before detection, whereas legitimate processes may not execute as quickly. In some embodiments, local feature sets include a feature indicative of whether the API call was signed, as legitimate computer processes are likely to be signed, indicating they are known within the computer environment, whereas malicious computer processes are less likely to be signed. In some embodiments, local feature sets include features indicative of file system objects and/or attributes of file system objects associated with the API call, as malicious processes such as ransomware are likely to target specific types of file system objects (e.g., content file system objects), files system objects in certain locations, and/or file system objects with certain attributes (e.g., size, last used, etc.) and skip over other file system objects such as with specific types (e.g., system files). In some embodiments, local feature sets may include features indicative of permissions associated with the API calls, as legitimate computer processes are likely to have known, specified permissions. In some embodiments, local feature sets may include features indicative of one or more actions associated with an API call, as malicious computer processes are likely to perform certain actions when infecting a computer environment, such as reading, writing, and deleting files during a ransomware attack. In some embodiments, a local feature set may include a feature indicative of a query structure associated with an API call, as such structures may be utilized by malicious processes when enumerating files and/or searching for files to infect. In some embodiments, local feature sets may include a feature indicative of opening characteristics of a file system object associated with the API call, as malicious computer processes are likely to use specific opening characteristics when enumerating and/or accessing files. In some embodiments, local feature sets may include a feature associated with creating a file system object associated with the API call, as malicious computer processes may create files (e.g., encrypted files) when infecting a computer environment.

As described above, in some embodiments, a global feature set may be generated from captured API calls data including data related to all captured API calls or a greater portion of captured API calls than the local feature set. In some embodiments a global feature set may include data related to the long-term behavior of a computer process (e.g., data indicative of the behavior of the process over its entire lifetime). In some embodiments, the global feature set may include data from a predetermined number of API calls, and/or data from API calls over a predetermined time period. In some embodiments, a global feature set may be generated using multiple API calls data sets generated from captured API calls data. In some embodiments, all API calls data sets may be used in generating a global feature set. In some embodiments, a subset of API calls data sets may be used in generating a global feature set (e.g., a most recent number of API calls data sets).

In some embodiments, global feature sets may include feature values derived from captured API call data. In some embodiments, global feature sets may include data related to the API calls within the global feature sets, for example, a global feature set may include feature values indicative of the percentage of each type of API call present within the captured API calls (e.g. a percentage of API calls related to opening file system objects, a percentage of API calls related to requesting file system object metadata, a percentage of API calls related to reading file system objects, a percentage of API calls related to writing to file system objects, a percentage of API calls related to creating file system objects, a percentage of API calls related to deleting file system objects, a percentage of API calls related to mapping a view to a virtual address space of a process, a percentage of API calls related to requesting computer process information, a percentage of API calls related to changing file system object information, a percentage of API Attorney calls related to requesting information about file system objects within a directory, a percentage of API calls related to searching a directory for a file, a percentage of API calls related to enumerating links to a specified file, a percentage of API calls related to searching a directory for a file with specified attributes, and/or a percentage of API calls related to continuing searching within a directory), whether the computer process making the API calls is digitally signed, a mean time difference between API calls, a standard deviation of time difference between API calls, a maximum time difference between API calls, and/or a minimum time difference between API calls.

In some embodiments, the features included in a global feature set are selected because they are likely to be indicative of a malicious computer process (e.g., malware, ransomware, etc.). In some embodiments, global feature sets include features indicative of the percentage of each type of API calls made by a computer process, as malicious processes are likely to be executing specific types of API calls in different proportions, for example, a ransomware attack may have a large proportion of read calls without associated write calls during file enumeration. In some embodiments, global features sets include a feature indicative of whether the computer process is signed, as signed computer processes are less likely to be malicious. In some embodiments, global feature sets include a feature indicative of a mean time difference between API calls made by the computer process, as malicious computer processes are likely to execute calls in rapid succession to maximize infection of a computer environment before detection. In some embodiments, global feature sets include a feature indicative of a standard deviation of the time differences between API calls made by the computer process, as a malicious computer process may have a low standard deviation of the time difference between calls because the calls are automated and may have a maximum time allowed between calls to ensure fast execution. In some embodiments, global feature sets may include a feature indicative of a maximum time difference between API calls made by the computer process, as malicious computer processes are unlikely to have large time differences between API calls. In some embodiments, global feature sets include a feature indicative of a minimum time difference between API calls made by the computer program, as legitimate computer processes are unlikely to have low time differences between API calls.

In some embodiments, local and global feature sets may not be generated from the captured API call data, and, instead, a single type of feature set is instead generated from captured API call data. In some embodiments, the feature set may include one or more of the feature values, as described above with reference to local feature sets and/or global feature sets. In some embodiments, the feature set may include feature values indicating a type of call, a time of the call, a time since a previous API call, a signature of the associated API call, file system objects associated with the API call, attributes of file system objects associated with the API call, permissions associated with the API call, one or more actions (e.g., access, read, write, move, delete, etc.) associated with the API call, a query structure associated with the API call, a feature indicative of opening characteristics of a file system object associated with the API call, a feature associated with creating a file system object associated with the API call, the percentage of each type of API call present within the captured API calls, whether the computer process making the API calls is digitally signed, a mean time difference between API calls, a standard deviation of time difference between API calls, a maximum time difference between API calls, and/or a minimum time difference between API calls. In some embodiments, the feature set may be generated to contain data related to a predetermined number of captured API calls, captured API calls made during a predetermined time period, and/or all captured API calls.

In some embodiments, the feature sets generated from the captured API call data may be analyzed using one or more trained machine learning (ML) models. In some embodiments, the feature sets generated from the captured API call data may be analyzed by multiple trained ML models, for example, a first model may analyze local feature sets, and a second model may analyze global feature sets. In some embodiments, the feature sets may be analyzed using a trained ML model which may analyze both local and global feature sets. In some embodiments, a trained ML model may analyze feature sets including features indicative of both the short-term and long-term behaviors of a computer process. In some embodiments, the feature sets generated from the captured API call data may be analyzed by a first trained ML model configured to analyze the short-term behavior of a computer process and a second trained ML model configured to analyze long-term behavior of a computer process. In some embodiments, the outputs of a first trained ML model may be analyzed by one or more other trained ML models to determine whether a computer process is malicious.

In some embodiments, the feature sets generated from the captured API call data may be analyzed using one or more of a: convolutional neural network (CNN), a Long Short-Term Memory (LSTM) model, a LSTM-CNN model, a gradient boosted decision tree model, a trained random forest model, a support vector classifier model, and/or a trained logistic regression model. In some embodiments, a CNN model for analyzing the feature sets generated from the captured API call data may include multiple layers, including one or more of: a convolutional layer, a pooling layer, a linear layer, a rectified linear unit (ReLU) layer, an attention mechanism, a fully connected layer and/or an embedding layer. In some embodiments, a LSTM model may include multiple layers including one or more of an LSTM layer, a sigmoid function layer, and/or an attention mechanism. In some embodiments, a LSTM-CNN model may include multiple layers, including one or more of: including one or more of: a convolutional layer, a pooling layer, a linear layer, a rectified linear unit (ReLU) layer, an attention mechanism, a fully connected layer, an embedding layer, an LSTM layer, and/or a sigmoid function layer.

In some embodiments, different types of trained ML models may analyze different behaviors of computer processes (e.g., short-term and long-term behaviors). In some embodiments, ML models are trained to determine whether a computer process is a malicious computer process based on short-term behavior of the computer process, for example by analyzing local feature sets and/or features indicative of short-term behavior of the computer process. In some embodiments, CNN models, LSTM model, and LSTM-CNN models are trained to analyze short-term behaviors of computer processes. In some embodiments, ML models are trained to determine whether a computer process is a malicious computer process based on long-term behavior of the computer process, for example by analyzing global feature sets and/or features indicative of long-term behavior of the computer process. In some embodiments, gradient boosted decision tree models, trained random forest models, support vector classifier models, and/or trained logistic regression models are trained to analyze long-term behaviors of computer processes.

In some embodiments, the one or mor trained ML models are trained to determine whether computer processes are malicious using training datasets. In some embodiments, the training datasets may include API calls data from legitimate computer processes and API calls data from malicious computer processes (e.g., ransomware, malware, etc.) executing in a computer environment. In some embodiments, a separate testing set of API calls data related to legitimate and malicious computer processes was reserved for validating ML model performance. In some embodiments, the training data was labeled to indicate whether API call data is associated with a legitimate or malicious computer process. Examples of legitimate computer processes that may be included in training data include one or more of: Everything, 7zip, WinRAR, VLC, ZOOM, Notepad++, Dropbox, WhatsApp, ESET Security, Norton Security, Microsoft Office, LibreOffice, Adobe PDF reader, Slack, Google Chrome, Mozilla Firefox, Google Drive, Foxit Reader, Qbittorrent, Team Viewer, CCleaner, OneDrive, Visual Studio, Spotify, VMware workstation, Total Commander, GoodSync, FBackup, MEGAsync, VeraCrypt, AxCrypt, Folder Lock, and/or Advanced Encryption Package, among other legitimate computer processes such as standard operating system processes and command line tools. Examples of malicious computer processes that may be included in training data include one or more of: Blackmatter, Blacksuit, Babuk, Avaddon, 8base, Conti, Medusa, Dragonforce, Akira, Maze, Pysa, Revil, Inc, Rhydisa, Blackhunt, Blackbasta and/or Lockbit, among other malicious computer processes including malware and ransomware samples.

In some embodiments, CNN, CNN-LSTM and other suitable models are trained using one or more of: gradient descent, stochastic gradient descent, and/or Adaptive Moment Estimation (ADAM), among other techniques for training ML models. In some embodiments, random forest models and other suitable models are trained using bootstrap aggregation.

In some embodiments, the outputs of the trained ML models may indicate whether a computer process is malicious. In some embodiments, the trained ML models may output a likelihood of the computer process being malicious. In some embodiments, the ML models may output a score (e.g., a numeric score) indicating whether the computer process is malicious. In some embodiments, the trained ML models may output a binary indication of whether the computer process is malicious (e.g., 0—malicious, 1—legitimate).

In some embodiments, the outputs of the one or more trained ML models may be analyzed to determine whether a computer process is malicious. In some embodiments, the one or more trained ML models may output a threat score indicative of whether the computer process is malicious, and it is determined the computer process is malicious when the threat score exceeds a threshold score. In some embodiments, where multiple ML models are used to analyze computer processes (e.g., a first ML model and a second ML model) it is determined a computer process is malicious when the threat score for each ML model exceeds a respective threshold score. In some embodiments, where multiple ML models are used to analyze computer processes (e.g., a first ML model and a second ML model) the threat scores output by the multiple models may be combined to determine a combined threat score, it is determined a computer process is malicious when the combined threat score exceeds a threshold score. In some embodiments, multiple ML model outputs may be generated for a given computer process, and it is determined that a computer process is malicious when a number of and/or number of most recent ML model outputs indicating the process is malicious exceeds a threshold number. In some embodiments, when respective first ML model outputs generated from multiple local feature sets and a second ML model output generated from a global feature set are generated for a given computer process, it is determined the computer process is malicious when a number of first ML model outputs and the second ML model output indicate the computer process is malicious. In some embodiments, when respective first ML model outputs generated from multiple local feature sets and a second ML model output generated from a global feature set are generated for a given computer process, it is determined the computer process is malicious when a number of most recent first ML model outputs and the second ML model output indicate the computer process is malicious. In some embodiments, when respective first ML model outputs generated from multiple local feature sets and a second ML model output generated from a global feature set are generated for a given computer process, a linear combination of outputs may be generated, and it is determined the computer process is malicious when the linear combination exceeds a threshold. In some embodiments, weights may be applied to each ML model outputs available for a given computer process or a most recent subset of ML model outputs available for the given computer process before determining the linear combination. In some embodiments, weights applied to the ML model outputs may be determined through an optimization process using real-world data captured from legitimate and malicious computer processes.

The inventors have appreciated that generating and analyzing feature sets which include features indicative of both the short-term and long-term behavior of a computer process provide for improved analysis of computer processes. For example, incorporation of the short-term and long-term features may provide improved accuracy in identifying malicious computer processes and reduce false positives, where legitimate computer processes are identified as malicious. The long-term and short-term behavior are important to consider when differentiating between legitimate and malicious computer processes. For example, some legitimate computer processes may have short-term behavior that appears malicious, such as a file backup process which accesses many file system objects in rapid succession. However, these short-term behaviors are temporary, and the same process will not appear malicious once the backup has completed, whereas a ransomware attack will continue accessing file system objects in rapid succession for longer than the file backup. Similarly, as ransomware and other malware advance to avoid detection, they may slowly infect computer environments and therefore appear to not be malicious in some short-term time windows, however, appears malicious when their long-term behavior is analyzed. Furthermore, the techniques described herein allow for analysis of behavioral trends and changes of a computer process, which may indicate whether the computer process is malicious or legitimate.

The inventors have appreciated that by utilizing multiple different ML models trained to determine whether a computer process is malicious based on short-term and long-term behavior of the process, the ultimate determination of whether the model is malicious can be improved. For example, high precision models such as CNN models, LSTM models, and/or CNN-LSTM models may be used to analyze the short-term behavior of the computer process and high recall models such as gradient boosted decision tree models, trained random forest models, support vector classifier models, and/or trained logistic regression models, may be used in analyzing the long-term behavior of the computer process. By using models trained to analyze the short-term and long-term behavior of computer processes, nuances of specific attacks may be better captured and differentiated from legitimate processes. The inventors have appreciated that similar benefits may be obtained from models trained to analyze both short and long-term behaviors of computer processes.

Furthermore, the inventors have appreciated that by utilizing a ML-based approach, the techniques described herein do not rely on known attacks or signatures or heuristics and therefore can recognize and adapt to new or changing attacks. In some embodiments, the data used in training the one or more ML models includes data obtained from legitimate computer processes, including legitimate processes associated with known computer applications (e.g., cloud storage applications, cybersecurity applications, word processing applications, enterprise software applications, among other, known computer applications). In some embodiments, the known, legitimate computer processes may be selected for training because they behave similarly to malicious processes (e.g., by enumerating many file system objects in a short period of time, reading many file system objects in a short period of time, or performing other behaviors similar to malicious processes). Such legitimate computer processes which behave similarly to malicious computer processes may commonly be falsely identified as malicious, therefore by training the one or more ML using these legitimate processes, the one or more ML models may have reduced rates of false positives. In some embodiments, the data used in training the one or more ML models includes data obtained from real-world malicious computer programs, including ransomware samples from one or more ransomware families. Therefore, because the one or more ML models are trained using real-world data from legitimate and malicious computer processes, the models improve upon conventional methods for ransomware detection because they do not rely on known patterns or depend on heuristic rules. Instead, the trained ML models learn the patterns that distinguish behavior of such malware (from benign processes) from the training data itself, which improves the accuracy and reliability of ransomware detection.

In some embodiments, when it is determined a computer process is malicious, the information security system may perform one or more cybersecurity actions to address the malicious process. In some embodiments, the one or more cybersecurity actions may include: terminating the computer process, isolating the computer process such that it may not access file system objects of the computer environment, and/or analyzing actions performed by the computer process to determine the extent of the ransomware attack.

While the techniques described herein are described with regard to mitigation of ransomware attacks, the inventors have recognized that the techniques may also protect computer environments against other types of malware which seek to gain access to and/or perform actions on file system objects of a computer environment. It should be appreciated that the techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

FIG. 1A shows an example environment 100 in which an information security system may operate, in accordance with some embodiments of the technology described herein. FIG. 1A includes computer environment 110 and ransomware attack(s) 130.

The components of computer environment 110 may be distributed in any suitable way. For example, in some embodiments, the components of computer environment 110 may be implemented as a single device. In some embodiments, the components of computer environment 110 may be implemented as multiple connected devices.

Computer environment 110 includes processor(s) 112, services 114, storage 116, applications 118 and information security system 120. Processors 112 may perform operations within the computer environment 110. Services 114 may include services associated with the operating system and functionality of the computer environment 110, for example, file management, memory management, and event logging, among other services. Applications 118 may include applications which users of computer environment 110 may interact with while using the computer environment, for example, word processing, web browsing, and image editing, among other applications. Storage 116 may store file system objects associated with the services 114, applications 118, information security system 120, and other objects necessary for the functioning of computer environment 110.

Information security system 120 may function to protect the computer environment 110 from various cybersecurity threats, for example ransomware attacks 130, spyware, and other types of malware. Information security system 120 is shown as internal to computer environment 110, however in some embodiments, one or more module(s) of information security system 120 may be deployed external to computer environment 110. The information security system 120 may function to identify and remediate cybersecurity threats.

FIG. 1B shows components of an example information security system within a computer environment, in accordance with some embodiments of the technology described herein. Information security system 120 may be configured to respond to ransomware attacks using the techniques described herein. As shown, the information security system 120 includes API call capture module 121, feature set generation module 122, trained ML model(s) 123, malware detection module 124, and malware remediation module 125.

The API call capture module 121 may analyze API calls made within the computer environment 110 to determine whether the API calls should be captured by the information security system for analysis. In some embodiments, the event capture module may only capture file system API calls (e.g., API calls related to interacting with the file system of the computer environment 110). In some embodiments, specific file system API calls may be captured for analysis, as described herein. For example, file system API calls related to one or more of: reading files, writing files, opening files, creating files, deleting files, allocating memory, mapping memory to a computer function, requesting file attributes, requesting computer process information, changing file object data, and/or requesting file metadata may be captured for analysis by the information security system 120. Examples of specific file system API calls are described herein. File system API calls may be captured and/or filter drivers implemented in the computer environment 110, which may automatically capture specific API calls for analysis by the information security system 120.

Feature set generation module 122 may generate feature sets from the captured API calls, as described herein. In some embodiments, feature set generation module 122 may generate feature sets when a predetermined amount of API calls have been captured and/or after a specified time period has passed, as described herein. In some embodiments, the feature set generation module may generate one or more types of feature sets, for example local feature sets and/or global feature sets as described herein.

Information security system 120 additionally includes trained ML model(s) 123. The trained ML model(s) 123 may include one or more trained ML models for processing the feature sets generated by feature set generation module 122. In some embodiments, the information security system 120 may include different types of ML models, examples of which are described herein. In some embodiments, the information security system 120 may include one or more trained ML models for analyzing the short-term behavior of computer processes (e.g., by analyzing local feature sets) and one or more trained ML models for analyzing the long-term behavior of computer processes (e.g., by analyzing global feature sets), as described herein.

The information security system 120 additionally includes malware detection module 124 and malware remediation module 125. Malware detection module 124 may function to determine whether the information security system 120 is undergoing a cybersecurity attack, for example by analyzing computer processes associated with malicious events and/or outputs of the trained ML model(s) 123, as described herein. Malware remediation module 125 may function to address cyber security attacks after they are identified, for example by terminating computer processes associated with cybersecurity attacks, isolating computer processes associated with cybersecurity attacks, and/or determining the impact of a cybersecurity attack on the computer environment 110. The information security system 120 may be configured to address ransomware attacks, such as ransomware attacks 130, and prevent these attacks from accessing and/or encrypting files within storage 116. Ransomware attacks 130 may be introduced into computer environment 110 through various sources, such as Internet downloaded files, files sent thorough internet communications, and/or files introduced through physically connected storage, among other sources.

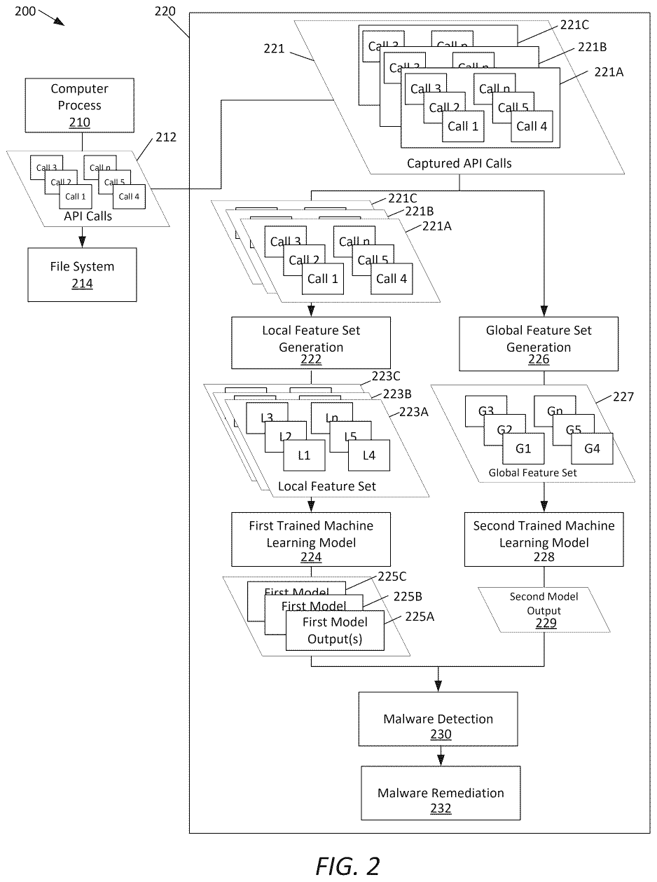

FIG. 2 is an example data flow which may be performed by an information security system deployed to a computer environment to identify malware, in accordance with some embodiments of the technology described herein. The process flow 200 of FIG. 2 may be performed within a computer environment such as computer environment 110 of FIG. 1A. As shown, computer process 210 is executing within the computer environment and makes API calls 212 to the file system 214 of the computer environment. Information security system 220 is deployed to the computer environment. Information security system 220 is an example information security system, and may include components similar to those discussed with reference to FIGS. 1A-1B. As shown, information security system 220 includes local feature set generation module 222, first trained ML model 224, global feature set generation module 226, second trained ML model 228, malware detection module 230 and malware remediation module 232.

While a single process 210 is shown, it should be appreciated that multiple computer processes may be executing within a computer environment at any given time and an information security system such as 120 of FIGS. 1A-B or information security system 220 of FIG. 2 may collect API call data for all computer processes or a subset of computer processes executing within a computer environment.

As shown, data related to at least some of the API calls 212 are captured by the information security system 220. Examples of data related to API calls which may be captured are described herein. The captured API calls data 221 may be captured by an API call capture module, such as API call capture module 121 described with reference to FIG. 1B. As shown, multiple sets of API calls data have been captured, including API call set 221A, set 221B and set 221C. In some embodiments, captured API calls may be grouped into sets of API calls according to when they are captured. In some embodiments each set of API calls may be generated to contain a predetermined number of API calls (e.g., 10,000 or other numbers of API calls as described herein) and/or API calls made during a predetermined time period (e.g., 5 minutes or other time periods as described herein). In some embodiments, when a set of API calls has been collected, the captured API calls data may be passed to local feature set generation module 222 and global feature set generation module 226.

As shown, the captured API call sets 221A, 221B and 222C are passed to local feature set generation module 222. While the three sets are shown being passed together, it is to be appreciated that the API call sets may be passed sequentially after each set is generated, with set 221A being passed first after it is generated based on a predetermined number of API calls or a predetermined time period, followed by set 221B and set 221C. The local feature set generation module 222 generates respective local feature sets 223A, 223B and 223C for each received API call set, 221A, 221B and 221C. The local feature sets may include feature values associated with API calls of the captured API calls. Specific examples of feature values which may be included in local feature sets are described herein, and in some embodiments include one or more of: a feature value indicative of a call type of an API call, a feature value indicative of a time since a previous API call, a feature value indicative of one or more requested file system objects associated with the API call, a feature value indicative of permissions associated with the API call, a feature value indicative of attributes of a file system object associated with the API call, a feature value indicative of actions associated with the API call, a feature value indicative of a query structure associated with the API call, a feature value indicative of opening a file system object associated with the API call, and/or a feature value associated with creating a file system object associated with the API call. The local feature sets may include data about specific API calls of the set of API calls and the short-term behavior of the computer process 210 (e.g., behavior over a most recent time period or a most recent set of API calls).

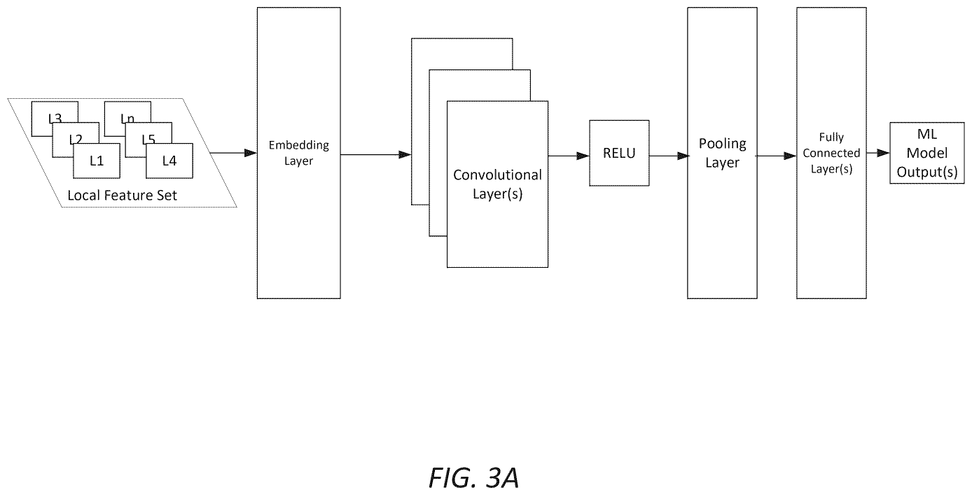

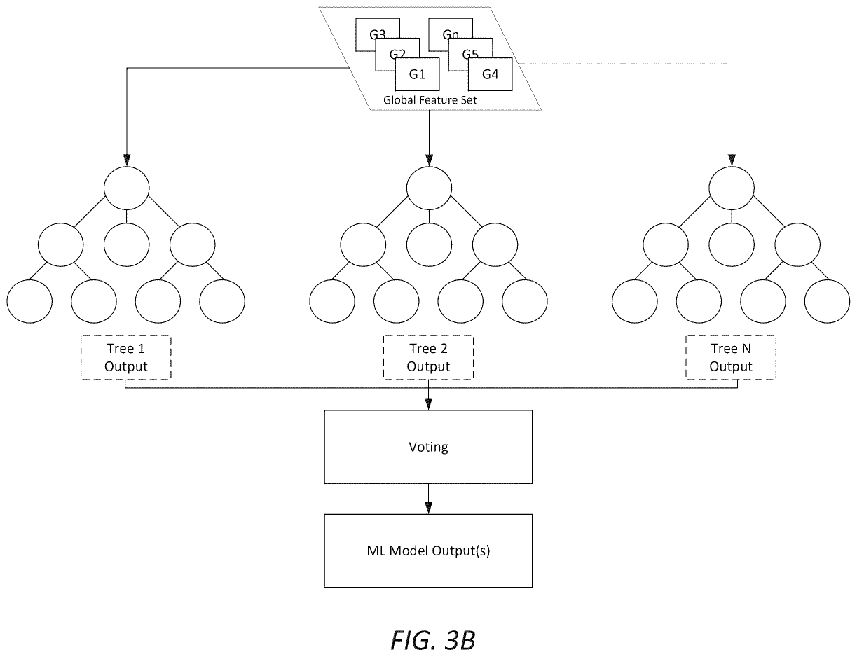

The local feature sets generated by the local feature set generation module 222, are passed to the first trained ML model 224. The first trained ML model may be trained to analyze the short term behavior of computer process 210 to determine whether the computer process is malicious. The first trained ML model may analyze each local feature set as it is received. Examples of ML models which may be used to analyze local feature sets are described herein, and may include CNN models and CNN-LSTM models, among other ML models. In some embodiments, the first trained ML model 223 may be a trained convolutional neural network, such as shown in FIG. 3A.

FIG. 3A is an example convolutional neural network which may be used by an information security system in identifying malware, in accordance with some embodiments of the technology described herein. The CNN may receive as an input a local feature set which includes feature values associated with captured API calls.

The feature set is first processed by an embedding layer which may generate a data embedding associated with each API call represented in the API call data set. In some embodiments, the embedding layer may generate data embeddings based on one or more features included within the local feature set. For example, embeddings may be generated on feature values representative of a type of API call. In some embodiments, embeddings may add dimensions to the data being processed by the CNN, for example an embedding based on a feature value representative of a type of API call may have multiple dimensions (e.g. 2, 3, 4, 5, or greater than 5 dimensions). In some embodiments, when embeddings increase the dimensions of the data being processed by the CNN, the embeddings may be concatenated together and/or concatenated with data of the local feature set.

The outputs of the embedding layer are passed to one or more convolutional layer(s). In some embodiments, the convolutional layer(s) may be ID convolutional layers and/or multidimensional convolutional layers. The convolutional layers are connected to a ReLU activation function, and the outputs are passed to a global pooling layer to reduce dimensionality. The pooled output is then passed to a fully connected layer using the ReLU activation. In some embodiments, multiple fully connected layers may be used, and the outputs of a first fully connected layer may be passed to a second fully connected layer. In some embodiments, the second fully connected layer may use a different activation function, e.g., a sigmoid activation function. The outputs of the fully connected layer(s) are indicative of whether the computer process associated with the local feature set is a malicious computer process. In some embodiments, the CNN may include additional layers, as described herein, for example a LSTM layer.

The CNN may be trained using labeled real-world data from malicious and legitimate computer processes. In some embodiments, the CNN may be trained using labeled local feature sets generated from real world API calls data from legitimate and malicious computer processes. The CNN may be trained using gradient descent, stochastic gradient descent, and/or Adaptive Moment Estimation (ADAM), as described herein.

According to one embodiment, a CNN was trained for analyzing local feature sets including a feature indicative of a type of API call and a feature indicative of a time since a previous API call. The CNN included an embedding layer that maps API calls to a dense representation such that an embedding for a particular API call type had a dimension of 4. The API call type embeddings were then concatenated to the features indicative of a time since last API call, such that the data input to the convolutional layers was a set of 5-dimensional vectors. The convolutional layers included a ID convolutional layer with 5 in channels, 32 out channels a kernel size of 8 and a stride of 1. A ReLU activation function was used. The convolutional layer outputs were passed to a global pooling layer, followed a first fully connected layer with 1024 neurons using the ReLU activation, followed by a second fully connected layer with 128 neurons using a sigmoid activation function. The final result is an indication, based on an input local feature set, of whether the associated computer process is malicious.

The model was trained using a data set including data from 796 legitimate computer processes and 18 ransomware samples executing in a WINDOWS® computer environment. The data set was split into training data, testing data, and validation data. The model was trained using the ADAM optimizer having a learning rate of 0.001 and a weight decay of 0.01. During testing the model achieved precision of 0.979, recall of 0.997, an F1 score of 0.988 and an accuracy of 0.988, when analyzing local feature sets representative of features of 10,000 API calls made by a computer process. With high precision and recall scores, the model effectively minimizes false positives and false negatives. Therefore, this model captures both the sequence context and categorical nuances of short-term behavior of malicious computer processes based on their API calls data.

Returning to FIG. 2, the first trained ML model 224 generates respective outputs 225A, 225B and 225C for each of the local feature sets 223A, 223B and 223C provided as inputs. The output(s) may then be provided to the malware detection module 230 for further analysis.

The captured API calls 221 are additionally passed to global feature set generation module 228. As shown, all of the captured API calls 221 are passed to global feature set generation module 228, including API call sets 221A, 221B and 221C. In some embodiments, less than all of the captured API calls may be provided to the global feature set generation module, for example, a subset of the captured API calls may be provided to the global feature set generation module 226, as described herein.

In some embodiments, the captured API calls data 221 may be passed to global feature set generation module 226 each time a set of API calls as generated and/or captured (e.g., every 10,000 or other numbers of API calls as described herein, and/or every 5 minutes or other time periods as described herein). In some embodiments, the captured API calls 221 may be sent to global feature set generation module 226 in conjunction with one or more sets of API calls being sent to local feature set generation module 222 (e.g., every time a set of API calls is sent to local feature set generation module, the captured API calls are sent to the global feature set generation module).

The global feature set generation module may process the captured API calls to generate global feature set 227. The global feature set generation module 226 may analyze the captured data related to the captured API calls to determine one or more feature values related to the captured API calls. Global feature set 227 may include one or more feature values indicative of the long-term behavior of the computer process, examples of specific feature values are included herein and may include one or more of: the percentage of each type of API call present within the captured API calls, whether the computer process making the API calls is digitally signed, a mean time difference between API calls, a standard deviation of time difference between API calls, a maximum time difference between API calls, and/or a minimum time difference between API calls.

The global feature set 227 may be passed to second trained ML model 228 for analysis. The second trained ML model 228 may be configured to analyze the long term behavior of the computer process based on the global feature set 227 to determine whether the computer process is a malicious computer process. Examples of trained ML models that may be used to determine whether a computer process is malicious based on global feature sets are described herein, and may include: a gradient boosted decision tree model, a trained random forest model, a support vector classifier model, and/or a trained logistic regression model. FIG. 3B is an example structure of a trained ML model that may be used to analyze global feature sets.

FIG. 3B is an example random forest model which may be used by an information security system in identifying malware, in accordance with some embodiments of the technology described herein.

As shown the random forest model receives a global feature set as an input, and the global feature set is passed to multiple decision trees. The random forest model may include any suitable number of decision trees (e.g., 1 decision tree, 5 decision trees, 10 decision trees, 50 decision trees, 100 decision trees, 200 decision trees, 500 decision trees, greater than 100 decision trees, or any number of decision trees between 1 and 100 decision trees). Each decision tree includes multiple decision nodes which may split the input data based on one or more randomly selected features that are analyzed by the node. Each decision tree may generate an output (e.g., an indication of whether the computer process is malicious), which are aggregated through voting to determine the ML model output(s) indicating whether the computer process is a malicious computer process. In some embodiments, the ML model outputs are determined through majority voting.

The decision tree may be trained through bootstrap aggregation or bagging, where each tree is trained individually on a random sample of a training dataset. In some embodiments, each tree may be trained on a random sample with replacement. In some embodiments, the training dataset may include labeled real-world data from malicious and legitimate computer processes. In some embodiments, the training dataset may include labeled global feature sets generated using real-world API calls data from malicious and legitimate computer processes.

According to one embodiment, a random forest model was trained to determine whether a computer process is a malicious computer process based on the long-term behavior of the computer process. The random forest model was trained using a bootstrap technique on a dataset including data from 796 legitimate computer processes and 18 ransomware samples operating in a WINDOWS® computer environment. The data set was split into training data, testing data, and validation data. The input to the random forest model was a global feature set with 21 feature values including: a percentage of NtOpenFile calls, a percentage of GetFileAttributes W calls, a percentage of GetFileAttributesExW calls, a percentage of NtWriteFile calls, a percentage of NtReadFile calls, a percentage of NtCreateFile calls, a percentage of NtDeleteFile calls, a percentage of NtMapViewOfSection calls, a percentage of NtQueryInformationProcess calls, percentage of NtSetInformationFile calls, percentage of NtQueryDirectoryFileEx calls, a percentage of NtQueryDirectoryFile calls, a percentage of FindFirstFileW calls, a percentage of FindFirstFileNameW calls, a percentage of FindFirstFileExW calls, a percentage of FindNextFileW calls, whether the process executable is digitally signed, a mean time difference between calls, a standard deviation of time difference between calls, a maximum time difference between calls, and a minimum time difference between calls. The trained random forest model was tested using global feature sets generated based on data obtained from different numbers of API calls, including 10,000 API calls, 100,000 API calls, and 1,000,000 API calls, made by real-world legitimate and malicious computer processes. When tested on the global feature sets generated from 10,000 API calls, the random forest model achieved an accuracy of 0.98, a precision of 0.99 for legitimate processes, a recall of 0.99 for legitimate processes, a F1 score of 0.99 for legitimate processes, a precision of 0.75 for malicious processes, a recall of 0.6 for malicious processes, and a F1 score of 0.67 for malicious processes. When tested on the global feature sets generated from 100,000 API calls, the random forest model achieved an accuracy of 1.00, a precision of 1.00 for legitimate processes, a recall of 1.00 for legitimate processes, a F1 score of 1.00 for legitimate processes, a precision of 1.00 for malicious processes, a recall of 1.00 for malicious processes, and a FI score of 1.00 for malicious processes. When tested on the global feature sets generated from 1,000,000 API calls, the random forest model achieved an accuracy of 0.99, a precision of 1.00 for legitimate processes, a recall of 0.99 for legitimate processes, a F1 score of 1.00 for legitimate processes, a precision of 0.83 for malicious processes, a recall of 1.00 for malicious processes, and a F1 score of 0.91 for malicious processes. The testing indicates that the trained random forest model is able to accurately identify malicious computer processes based on their long term behaviors, as the model achieved a recall of 1.00 for both the 100,000 and 1,000,000 API call global feature sets. This indicates that the model correctly identified malicious computer processes as malicious as additional data became available. Furthermore, the model maintained a low false positive rate across all numbers of API calls used in the global feature set, indicating that it accurately analyzes the long-term behavior of computer processes to identify malicious computer processes.

Returning to FIG. 2, the second ML model output 229 is passed to malware detection module 230 for analysis. The malware detection module 230 may determine whether computer process 210 is malicious based on the first and second ML model outputs. In some embodiments, it is determined that the computer process is malicious when the most recent first trained ML model output and the second ML model output indicate the computer process is malicious. In some embodiments, it is determined that the computer process is malicious when a proportion and/or number of first ML model outputs greater than a threshold proportion and/or number indicate the computer process is malicious and the second ML model output indicates the model is malicious. In some embodiments, the malware detection module may determine a threat score for the computer process 210 based on the first and second ML model outputs (e.g., by weighting the outputs) and may determine the computer process 210 is malicious when the threat score exceeds a threshold.

By combining the outputs from the first trained ML model 224 and second trained ML model 228, the identification of malicious computer processes within the computer environment is more accurate, as both short-term and long-term behavior of the computer processes are analyzed, which allows proper context to be incorporated into the analysis of computer processes.

In some embodiments, when it is determined the computer process 210 is not malicious, the process ends and no action is taken. In some embodiments, after it is determined the process 210 is not malicious, the analysis shown in FIG. 2 may be performed again for process 210 as additional API calls are collected.

In some embodiments, when it is determined that the computer process 210 is malicious, one or more cybersecurity actions may be performed by malware remediation module 232. In some embodiments the malware remediation module 232 may terminate computer process 210, isolate computer process 210 such that it may not access file system objects of the computer environment, and/or analyze actions performed by computer process 210 to determine the extent of the ransomware attack.

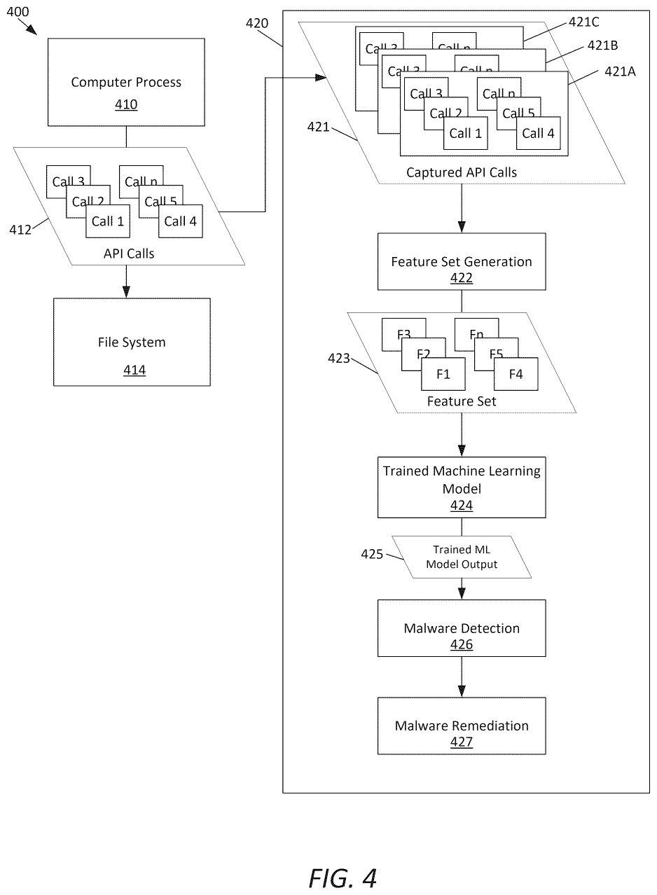

FIG. 4 is an alternative example data flow which may be performed by an information security system deployed to a computer environment to identify malware, in accordance with some embodiments of the technology described herein. The process flow 400 of FIG. 4 may be performed within a computer environment such as computer environment 110 of FIG. 1A. As shown, computer process 410 is executing within the computer environment and makes API calls 412 to the file system 414 of the computer environment. Information security system 420 is deployed to the computer environment. Information security system 420 is an example information security system, and may include components similar to those discussed with reference to FIGS. 1A-1B. As shown, information security system 420 includes feature set generation module 422, trained ML model 424, malware detection module 426 and malware remediation module 427.

While a single process 410 is shown, it should be appreciated that multiple computer processes may be executing within a computer environment at any given time and an information security system such as 120 of FIGS. 1A-B or information security system 420 of FIG. 4 may collect API call data for all computer processes or a subset of computer processes executing within a computer environment.

As shown, data related to at least some of the API calls 412 are captured by the information security system 420. Examples of data related to API calls which may be captured are described herein. The captured API calls data 421 may be captured by an API call capture module, such as API call capture module 121 described with reference to FIG. 1B. As shown, multiple sets of API calls have been captured, including API call set 421A, set 421B and set 421C. In some embodiments, when a set of API calls has been collected, the captured API calls data may be passed to feature set generation module 422. In some embodiments, data related to all captured API calls is provided to feature set generation module 422. In some embodiments, a subset of the captured API calls data may be provided to feature set generation module 422. In some embodiments, a most recent set of captured API calls is provided to feature set generation module 422.

The feature set generation module 422 generates a feature set 423 from the captured API calls data 421. The feature set may include feature values associated with API calls of the captured API calls. Specific examples of feature values which may be included in feature set are described herein, and may include feature values related to specific API calls, feature values related to the short-term behavior of the computer process 410, and/or feature values related to the long-term behavior of the computer process 410.

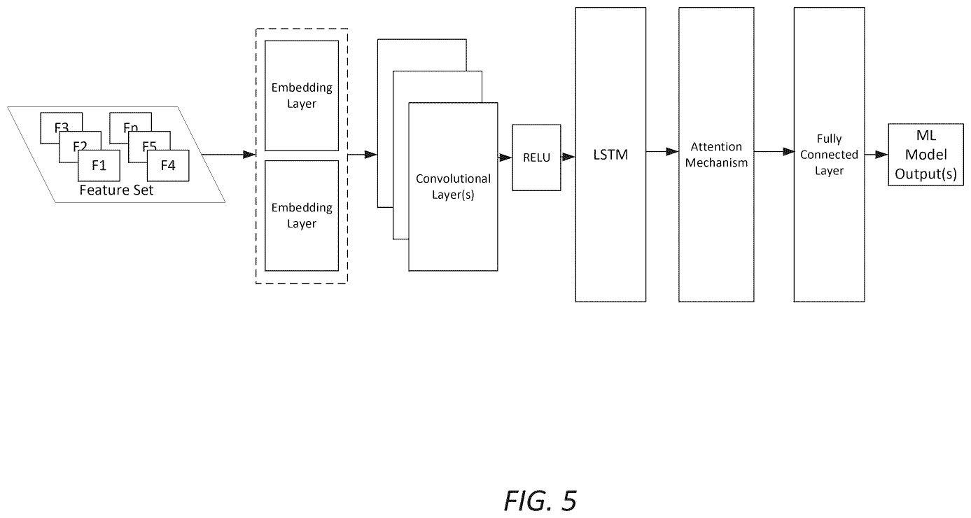

The feature set 423 generated by the feature set generation module 422, is passed to the trained ML model 424. The trained ML model may be trained to analyze the short-term and/or long-term behavior of computer process 410 to determine whether the computer process is malicious. The trained ML model may analyze each feature set as it is received. Examples of ML models which may be used to analyze feature sets are described herein. In some embodiments, the trained ML model 424 may be a trained convolutional neural network with a long short-term memory layer, such as shown in FIG. 5.

FIG. 5 is an example convolutional neural network with a long short-term memory layer, which may be used by an information security system in identifying malware, in accordance with some embodiments of the technology described herein. The CNN-LSTM model receives as an input a feature set, such as feature set 423 generated by feature set generation module 422.

The feature set is first processed by an embedding layer which may generate a data embedding associated with each API call represented in the API call data set. In some embodiments, the embedding layer may generate data embeddings based on one or more features included within the local feature set. For example, embeddings may be generated on feature values indicative of a type of API call, or feature values indicative of a query structure associated with an API call, among other feature values described herein. In some embodiments, embeddings may add dimensions to the data being processed by the CNN, for example an embedding based on a feature value representative of a type of API call and/or a query structure associated with an API call may have multiple dimensions (e.g. 2, 3, 4, 5, or greater than 5 dimensions). In some embodiments, when embeddings increase the dimensions of the data being processed by the CNN, the embeddings may be concatenated together and/or concatenated with data of the local feature set.

The outputs of the embedding layer are passed to one or more convolutional layer(s). In some embodiments, the convolutional layer(s) may be ID convolutional layers and/or multidimensional convolutional layers. The convolutional layers are connected to a ReLU activation function, and the outputs are passed to a LSTM layer. The LSTM layer may allow for analysis of the long-term behavior of a computer process, as the layer may be trained to identify long-term dependencies in data. The LSTM may include multiple connected LSTM units which include input, output and forget gates. The connected LSTM units may pass data between each other via their gates, which may include information related to historic data and/or dependencies. The LSTM layer may be trained to identify when data should be retained (e.g., passed vis input and output gates to other LSTM units) or when data should be discarded (e.g., via the forget gates). This training allows the LSTM to learn long-term dependencies that indicate whether a computer program is malicious.

The outputs of the LSTM layer are provided to an attention mechanism. The attention mechanism may assign weights to different LSTM time steps that are output from the LSTM layer. The attention mechanism may use softmax normalization to determine the importance of each time step and assign weights to the time steps output from the LSTM layer. The attention mechanism may output a context vector which is computed as a weighted sum of LSTM outputs.

The context vector may be passed to a fully connected layer for classification. In some embodiments, the fully connected layer may use a sigmoid function as an activation function. In some embodiments other suitable activation functions may be used, for example a ReLU activation function. The fully connected layer may then generate ML model output(s). In some embodiments, the ML model output is a probability score representing the likelihood of the computer process being malicious. In some embodiments, the ML model output is an indication of whether the computer process is malicious.

The CNN-LSTM model may be trained using labeled real-world data from malicious and legitimate computer processes. In some embodiments, the CNN-LSTM model may be trained using labeled local feature sets generated from real world API calls data from legitimate and malicious computer processes. The CNN-LSTM may be trained using gradient descent, stochastic gradient descent, and/or Adaptive Moment Estimation (ADAM), as described herein.

According to one embodiment, a CNN-LSTM model was trained for analyzing feature sets including a feature indicative of a type of API call, a feature indicative of a query structure associated with an API call, and a feature indicative of a time since a previous API call. The CNN-LSTM model was trained for analyzing API calls made in a WINDOWS® computer environment and the feature value indicative of a query structure associated with the API call is a FileInformationClass feature associated with the API call. The CNN-LSTM model included an embedding layer that maps API calls to a dense representation such that an embedding generated based on an API call type feature value had a dimension of 4 and an embedding generated based on a query structure associated with an API call had a dimension of 4. The embeddings were then concatenated to the features indicative of a time since last API call, such that the data input to the convolutional layers was a set of 9-dimensional vectors. The convolutional layers included a ID convolutional layer with 9 in channels, 64 out channels a kernel size of 32 and a stride of 32. A ReLU activation function was used for the convolutional layer. The convolutional layer outputs were passed to a LSTM layer. The LSTM layer had a hidden size of 128, two layers, and a true batch first. The output of the LSTM layer is provided to an attention mechanism. The attention mechanism includes a learnable attention layer which assign weights to the LSTM time steps output by the LSTM layer. The learnable attention layer is a linear layer and has a hidden size of 128. The attention mechanism uses softmax normalization to determine the importance of each time step output by the LSTM and a context vector is computed as a weighted sum of LSTM outputs. The context vector is passed through a sigmoid activation function to generate the ML model output indicating whether the computer process is malicious.

The CNN-LSTM model was trained using a data set of API calls data collected in a WINDOWS® computer environment including data from 796 legitimate computer processes and 18 ransomware samples. The data set was split into training data, testing data, and validation data. The model was trained using the ADAM optimizer having a learning rate of 0.0001 and a weight decay of 0.01, for 200 epochs. During testing the model achieved precision of 0.968, recall of 1.00, an Fl score of 0.984 and an accuracy of 0.983, when analyzing feature sets representative of features of 10,000 API calls made by real-world computer processes executing in a WINDOWS® computer environment. The high precision and recall indicate the CNN-LSTM model can minimize false positives and false negatives when analyzing API calls made by computer processes. The CNN-LSTM model therefore can accurately identify malicious computer programs based on API calls data and learned dependencies between API calls.

Returning to FIG. 4, the trained ML model output 425 is provided to malware detection module 426. The malware detection module may determine whether the computer process 410 is malicious based on the trained ML model output. In some embodiments, the malware detection module 426 may determine whether the computer process 410 is malicious based on a most recent trained ML model output. In some embodiments, the malware detection module 426 may determine whether the computer process 410 is malicious based on multiple trained ML model outputs.

In some embodiments, when it is determined the computer process 410 is not malicious, the process ends and no action is taken. In some embodiments, after determining the process 410 is not malicious, the analysis shown in FIG. 4 may be performed again for process 410 as additional API calls are collected.

In some embodiments, when it is determined that the computer process 410 is malicious, one or more cybersecurity actions may be performed by malware remediation module 427. In some embodiments the malware remediation module 427 may terminate computer process 410, isolate computer process 410 such that it may not access file system objects of the computer environment, and/or analyze actions performed by computer process 410 to determine the extent

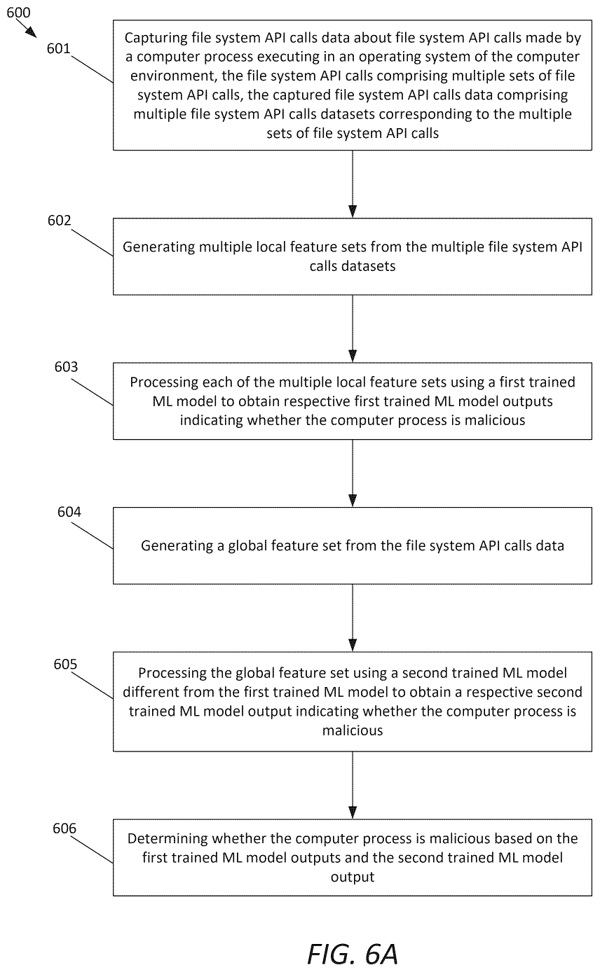

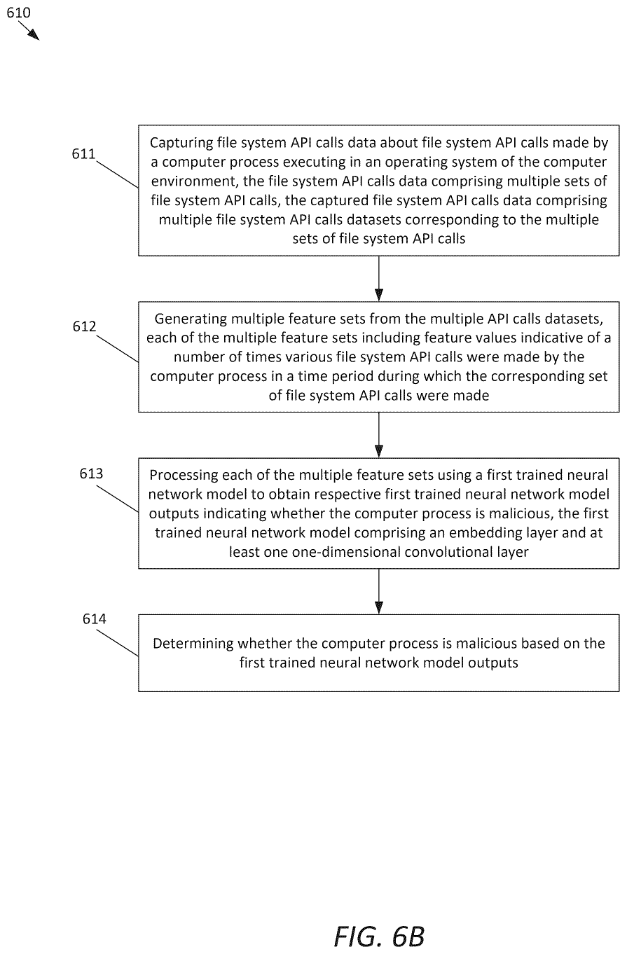

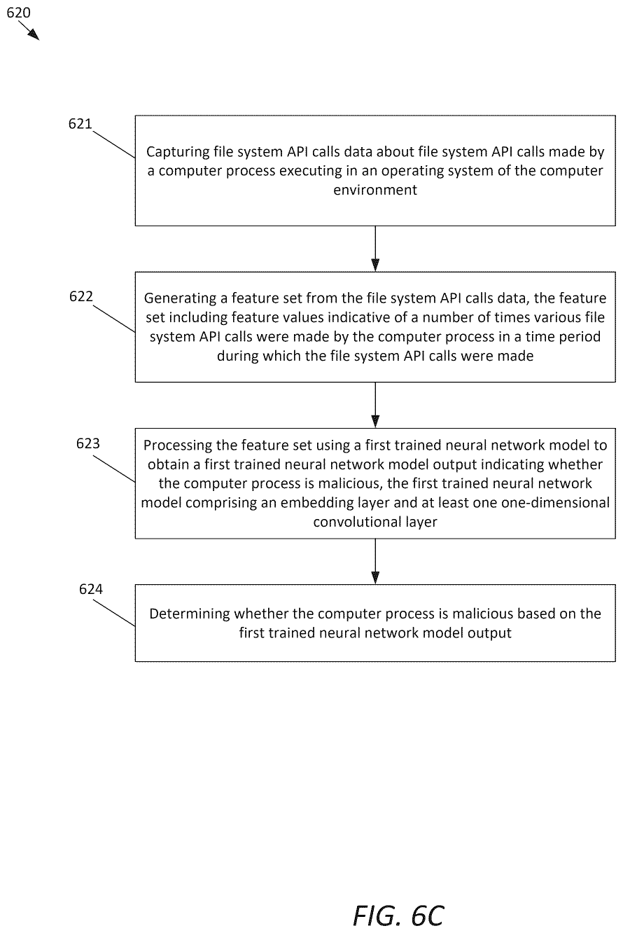

FIG. 6A is an example process for identifying a malicious computer process, in accordance with some embodiments of the technology described herein. The process 600 of FIG. 6A may be performed by an information security system deployed to a computer environment, as described herein, for example, information security systems 120 and 220, as described with reference to FIGS. 1A-B and 2, respectively.

Process 600 begins with act 601, in which file system API calls data about file system API calls made by a computer process executing in an operating system of the computer environment is captured, the file system API calls comprising multiple sets of file system API calls, the captured file system API calls data comprising multiple file system API calls datasets corresponding to the multiple sets of file system API calls. In some embodiments, the API calls may be captured based on a type of call, as described herein. In some embodiments, sets of API calls may be captured after data related to a predetermined number of API calls is captured and/or after a predetermined amount of time, as described herein. Act 601 may be performed by an API Call Capture Module of an information security system, for example API call capture module 121 of FIG. 1B.

Process 600 then proceeds to act 602, in which multiple local feature sets are generated from the multiple file system API calls datasets. In some embodiments, the local feature sets may include multiple feature values, related to the captured API calls data. Examples of feature values which may be included in a local feature set are described herein. In some embodiments, the local feature sets may include data related to the current and/or short-term behavior of the computer process, as described herein. Act 602 may be performed by a local feature set generation module, such as module 222 of FIG. 2, or by a feature set generation module such as module 122 of FIG. 1B.

Process 600 then proceeds to act 603, in which each of the multiple local feature sets are processed using a first trained ML model to obtain respective first trained ML model outputs indicating whether the computer process is malicious. Examples of trained ML models that may analyze local feature sets are described herein, such as with reference to FIGS. 1B, 2 and 3A. The first trained ML model may be trained to analyze the short-term behavior of the computer process based on the local feature sets. Act 603 may be performed by a trained ML model such as trained ML models 123 of FIG. 1B, or first trained ML model 224 of FIG. 2.

Process 600 then proceeds to act 604, in which a global feature set is generated from the file system API calls data. In some embodiments, all captured API calls data may be used in generating the global feature set, as described herein. In some embodiments, a subset of the captured API calls data may be used in generating the global feature set, as described herein. The global feature set may include feature values indicative of the long-term behavior of the computer process. Examples of feature values that may be included in a global feature set are described herein. Act 604 may be performed by a global feature set generation module, such as module 226 as described with reference to FIG. 2 or a feature set generation module, such as module 122 as described with reference to FIG. 1B.

Process 600 then proceeds to act 605, in which the global feature set is processed using a second trained ML model different from the first trained ML model to obtain a respective second trained ML model output indicating whether the computer process is malicious. Examples of trained ML models that may analyze global feature sets are described herein, such as with reference to FIGS. 1B, 2 and 3B. The second trained ML model may be trained to analyze the long-term behavior of the computer process based on the local feature sets. Act 605 may be performed by a trained ML model such as trained ML models 123 of FIG. 1B, or second trained ML model 228 of FIG. 2.

Process 600 then proceeds to act 606, in which it is determined whether the computer process is malicious based on the first trained ML model output and the second trained ML model output. In some embodiments, it is determined that the computer process is malicious when the first ML model output and the second ML model output indicates that the computer process is malicious. In some embodiments, it is determined that the computer process is malicious when a proportion and/or number of first ML model outputs greater than a threshold proportion and/or number indicate the computer process is malicious and the second ML model output indicates the model is malicious. In some embodiments, when it is determined that the computer process is malicious one or more cybersecurity actions may be performed, as described herein. Act 606 may be performed by a malware detection module, as described herein, such as module 124 of FIG. 1B, or module 230 of FIG. 2.

FIG. 6B is an alternate example process for identifying a malicious computer process, in accordance with some embodiments of the technology described herein. The process 610 of FIG. 6B may be performed by an information security system deployed to a computer environment, as described herein, for example, information security systems 120, 220, and 420 as described with reference to FIGS. 1A-B, 2, and 4 respectively.

Process 610 begins with act 611, in which file system API calls data about file system API calls made by a computer process executing in an operating system of the computer environment, the file system API calls data comprising multiple sets of file system API calls, the captured file system API calls data comprising multiple file system API calls datasets corresponding to the multiple sets of file system API calls. In some embodiments, the API calls may be captured based on a type of call, as described herein. In some embodiments, sets of API calls may be captured after data related to a predetermined number of API calls is captured and/or after a predetermined amount of time, as described herein. Act 611 may be performed by an API Call Capture Module of an information security system, for example API call capture module 121 of FIG. 1B.

Process 610 then proceeds to act 612, in which multiple feature sets are generated from the multiple API calls datasets, each of the multiple feature sets including feature values indicative of a number of times various file system API calls were made by the computer process in a time period during which the corresponding set of file system API calls were made. Act 612 may be performed by a feature set generation module, such as modules 122 of FIG. 1B, module 222 of FIG. 2, and module 422 of FIG. 4.

Process 610 then proceeds to act 613, in which each of the multiple feature sets are processed using a first trained neural network model to obtain respective first trained neural network model outputs indicating whether the computer process is malicious, the first trained neural network model comprising an embedding layer and at least one one-dimensional convolutional layer. Examples of trained neural networks for analyzing feature sets are described herein, such as with reference to FIGS. 1B, 2, 3A, 4 and 5.

Process 610 then proceeds to act 614, in which it is determined whether the computer process is malicious based on the first trained neural network model output. In some embodiments, when it is determined that the computer process is malicious one or more cybersecurity actions may be performed, as described herein. Act 614 may be performed by a malware detection module, as described herein, such as module 124 of FIG. 1B, module 230 of FIG. 2 and module 426 of FIG. 4.

FIG. 6C is an alternate example process for identifying a malicious computer process, in accordance with some embodiments of the technology described herein. The process 620 of FIG. 6C may be performed by an information security system deployed to a computer environment, as described herein, for example, information security systems 120, 220, and 420 as described with reference to FIGS. 1A-B, 2, and 4 respectively.

Process 620 begins with act 621, in which file system API calls data about file system API calls made by a computer process executing in an operating system of the computer environment is captured. In some embodiments, the API calls may be captured based on a type of call, as described herein. In some embodiments, sets of API calls may be captured after data related to a predetermined number of API calls is captured and/or after a predetermined amount of time, as described herein. Act 621 may be performed by an API Call Capture Module of an information security system, for example API call capture module 121 of FIG. 1B.

Process 620 then proceeds to act 622, in which a feature set is generated from the file system API calls data, the feature set including feature values indicative of a number of times various file system API calls were made by the computer process in a time period during which the file system API calls were made. Act 622 may be performed by a feature set generation module, such as modules 122 of FIG. 1B, module 222 of FIG. 2, and module 422 of FIG. 4.

Process 620 then proceeds to act 623, in which the multiple feature set is processed using a first trained neural network model to obtain a first trained neural network model output indicating whether the computer process is malicious, the first trained neural network model comprising an embedding layer and at least one one-dimensional convolutional layer. Examples of trained neural networks for analyzing feature sets are described herein, such as with reference to FIGS. 1B, 2, 3A, 4 and 5.

Process 620 then proceeds to act 624, in which it is determined whether the computer process is malicious based on the first trained neural network model output. In some embodiments, when it is determined that the computer process is malicious one or more cybersecurity actions may be performed, as described herein. Act 624 may be performed by a malware detection module, as described herein, such as module 124 of FIG. 1B, module 230 of FIG. 2 and module 426 of FIG. 4.

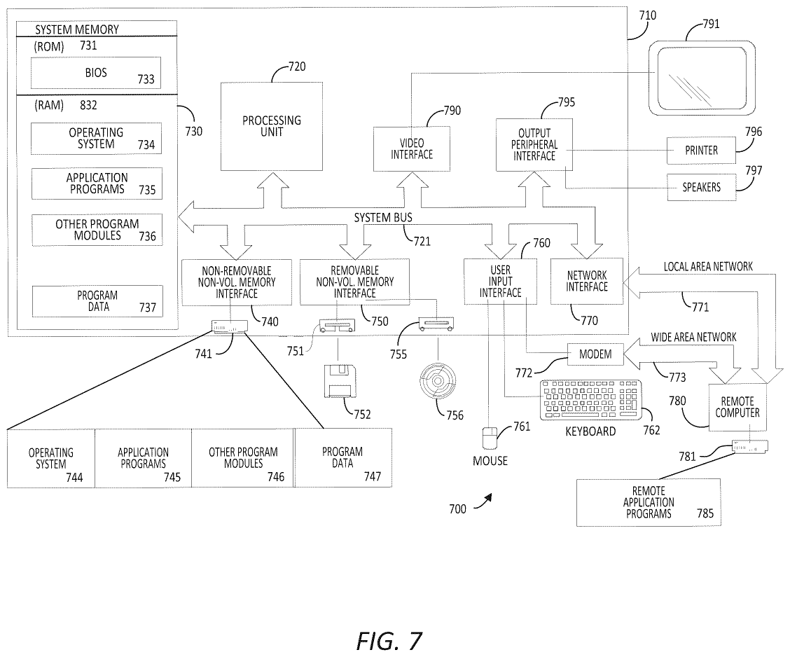

FIG. 7 shows a block diagram of an exemplary computing device, in accordance with some embodiments of the technology described herein. The computing system environment 700 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the technology described herein includes a general-purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 431 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile or nonvolatile computer storage media. By way of example only, FIG. 7 illustrates a hard disk drive 741 that reads from or writes to non-removable, nonvolatile magnetic media, a flash drive 751 that reads from or writes to a removable, nonvolatile memory 752 such as flash memory, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media described above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. An actor may enter commands and information into the computer 710 through input devices such as a keyboard 762 and pointing device 761, commonly referred to as a mouse, trackball, or touch pad. Other input devices (not shown) may include a microphone, joystick, game pad, satellite dish, scanner, or the like. These and other input devices are often connected to the processing unit 720 through a user input interface 760 that is coupled to the system bus but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device, or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773 but may also include other networks. Such networking environments are commonplace in offices, enterprise-wide computer networks, intranets, and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the actor input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 2, 4, and 6A-C. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing.” “involving,” “holding,” “composed of,” and the like are to be understood to be open-ended, i.e., to mean including but not limited to. Only the transitional phrases “consisting of” and “consisting essentially of”′ shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A method for mitigating malware attacks in a computer environment by applying one or more trained machine learning (ML) models to features derived from file system application programming interface (API) calls made by computer processes executing in the computer environment, the method comprising:
using at least one computer hardware processor to perform:
capturing file system API calls data about file system API calls made by a computer process executing in an operating system of the computer environment, the file system API calls comprising multiple sets of file system API calls, the captured file system API calls data comprising multiple file system API calls datasets corresponding to the multiple sets of file system API calls;
generating multiple local feature sets from the multiple file system API calls datasets;
processing each of the multiple local feature sets using a first trained ML model to obtain respective first trained ML model outputs indicating whether the computer process is malicious;
generating a global feature set from the file system API calls data;
processing the global feature set using a second trained ML model different from the first trained ML model to obtain a respective second trained ML model output indicating whether the computer process is malicious; and
determining whether the computer process is malicious based on the first trained ML model outputs and the second trained ML model output.

2. The method of claim 1, wherein capturing file system API calls data comprises capturing data about file system API calls related to one or more of: reading files, writing files, opening files, creating files, deleting files, allocating memory, mapping memory to a computer function, requesting file attributes, requesting computer process information, changing file object data, and/or requesting file metadata.

3. The method of claim 1, wherein the computer environment is a WINDOWS® computer environment, and wherein capturing file system API calls data comprises capturing data about file system API calls including: NtOpenFile, GetFileAttributesW, GetFileAttributesEx W, NtWriteFile, NtReadFile, NtCreateFile, NtDeleteFile, NtMap ViewOfSection, NtQueryInformationProcess, NtSetInformationFile, NtQuery DirectoryFileEx, NtQueryDirectoryFile, FindFirstFileW, FindFirstFileNameW, FindFirstFileExW, and/or FindNextFileW.

4. The method of claim 1, wherein each file system API call dataset of the multiple file system API calls datasets and each local feature set of the multiple local feature sets comprise data related to between 5,000 and 15,000 API calls.

5. The method of claim 1, wherein the multiple local feature sets include a first local feature set corresponding to a first data set of API calls, the first local feature set comprising a first set of feature values derived for a first API call, the first set of feature values including: a feature value indicative of a call type of the first API call, a feature value indicative of a time since a previous API call, a feature value indicative of one or more requested file system objects associated with the first API call, a feature value indicative of permissions associated with the first API call, a feature value indicative of attributes of a file system object associated with the first API call, a feature value indicative of actions associated with the first API call, a feature value indicative of a query structure associated with the first API call, a feature value indicative of opening a file system object associated with the first API call, and/or a feature value associated with creating a file system object associated with the first API call.

6. The method of claim 1, wherein the first trained ML model comprises a trained neural network model.

7. The method of claim 6, wherein the trained neural network model comprises at least one one-dimensional convolutional layer.

8. The method of claim 7, wherein the trained neural network model is a convolutional neural network model, comprising an embedding layer, the at least one one-dimensional convolutional layer, a pooling layer, and a fully-connected layer.

9. The method of claim 8, wherein the trained neural network model comprises an embedding layer, the at least one one-dimensional convolutional layer, a long short-term memory (LSTM) layer, an attention mechanism, and a fully-connected layer.

10. The method of claim 1, wherein the global feature set comprises data related to the file system API calls made by the computer process, including one or more of: proportions of API call types of the file system API calls made by the computer process, whether the computer process is signed, a mean time difference between the API calls made by the computer process, a standard deviation of time differences between the API calls made by the computer process, a maximum time difference between API calls made by the computer process, and/or a minimum time difference between API calls made by the computer process.

11. The method of claim 1, wherein the second trained ML model comprises a trained random forest model.

12. The method of claim 1, wherein the second trained ML model comprises a trained random forest model, a support vector classifier, a trained logistic regression model, or a gradient boosted decision tree model.

13. The method of claim 1, wherein:
the determining comprises determining the computer process is malicious when a combined threat score based on the first trained ML outputs and the second trained ML model output exceeds a threshold score.

14. The method of claim 1, wherein:
the determining comprises determining the computer process is malicious when:
a number of first trained ML outputs indicating the computer process is malicious exceeds a threshold; and
the second trained ML output indicates the computer process is malicious.

15. The method of claim 1, further comprising:
when it is determined the computer process is malicious, performing one or more of:
isolating the computer process;
terminating the computer process; and/or
analyzing actions performed by the computer process.

16. A system for mitigating malware attacks in a computer environment, the system comprising:
at least one computer hardware processor; and
at least one non-transitory computer-readable storage medium storing processor-executable instructions that, when executed by the at least one computer hardware processor, causes the at least one computer hardware processor to perform a method for mitigating malware attacks in the computer environment by applying one or more trained machine learning (ML) models to features derived from file system application programming interface (API) calls made by computer processes executing in the computer environment, the method comprising:
capturing file system API calls data about file system API calls made by a computer process executing in an operating system of the computer environment, the file system API calls comprising multiple sets of file system API calls, the captured file system API calls data comprising multiple file system API calls datasets corresponding to the multiple sets of file system API calls;
generating multiple local feature sets from the multiple file system API calls datasets;
processing each of the multiple local feature sets using a first trained ML model to obtain respective first trained ML model outputs indicating whether the computer process is malicious;
generating a global feature set from the file system API calls data;
processing the global feature set using a second trained ML model different from the first trained ML model to obtain a respective second trained ML model output indicating whether the computer process is malicious; and
determining whether the computer process is malicious based on the first trained ML model outputs and the second trained ML model output.

17. The system of claim 16, wherein capturing file system API calls data comprises capturing data about file system API calls related to one or more of: reading files, writing files, opening files, creating files, deleting files, allocating memory, mapping memory to a computer function, requesting file attributes, requesting computer process information, changing file object data, and/or requesting file metadata.

18. The system of claim 16, wherein the multiple local feature sets include a first local feature set corresponding to a first data set of API calls, the first local feature set comprising a first set of feature values derived for a first API call, the first set of feature values including: a feature value indicative of a call type of the first API call, a feature value indicative of a time since a previous API call, a feature value indicative of one or more requested file system objects associated with the first API call, a feature value indicative of permissions associated with the first API call, a feature value indicative of attributes of a file system object associated with the first API call, a feature value indicative of actions associated with the first API call, a feature value indicative of a query structure associated with the first API call, a feature value indicative of opening a file system object associated with the first API call, and/or a feature value associated with creating a file system object associated with the first API call.

19. The system of claim 16, wherein the method further comprises:
when it is determined the computer process is malicious, performing one or more of:
isolating the computer process;
terminating the computer process; and/or
analyzing actions performed by the computer process.

20. At least one non-transitory computer-readable storage medium storing processor-executable instructions that, when executed by at least one computer hardware processor, causes the at least one computer hardware processor to perform a method for mitigating malware attacks in a computer environment by applying one or more trained machine learning (ML) models to features derived from file system application programming interface (API) calls made by computer processes executing in the computer environment, the method comprising:
capturing file system API calls data about file system API calls made by a computer process executing in an operating system of the computer environment, the file system API calls comprising multiple sets of file system API calls, the captured file system API calls data comprising multiple file system API calls datasets corresponding to the multiple sets of file system API calls;
generating multiple local feature sets from the multiple file system API calls datasets;
processing each of the multiple local feature sets using a first trained ML model to obtain respective first trained ML model outputs indicating whether the computer process is malicious;
generating a global feature set from the file system API calls data;
processing the global feature set using a second trained ML model different from the first trained ML model to obtain a respective second trained ML model output indicating whether the computer process is malicious; and
determining whether the computer process is malicious based on the first trained ML model outputs and the second trained ML model output.

21-50. (canceled)
